(19) United States
(12) Patent Application Publication
(10) Pub. No.: US 2022/0057561 A1
(43) Pub. Date: Feb. 24, 2022

(54) APPARATUS COMPRISING A LIGHT GUIDE PLATE WITH FEATURES AND METHODS FOR USING THE SAME TO DIRECT LIGHT

(71) Applicant: Corning Incorporated, Corning, NY (US)

(72) Inventors: Patrick Scott Leslie, Tucson, AZ (US); Shenping Li, Painted Post, NY (US); Leonard Thomas Masters, Painted Post, NY (US); Johannes Moll, Corning, NY (US); Craig John Mancusi Ungaro, Corning, NY (US)

(21) Appl. No.: 17/421,176

(22) PCT Filed: Jan. 7, 2020
(86) PCT No.: PCT/US2020/012484

§ 371 Date: Jul. 7, 2021

Related U.S. Application Data
(60) Provisional application No. 62/790,048, filed on Jan. 9, 2019.
(60) Provisional application No. 62/949,645, filed on Dec. 18, 2019.

(51) Int. Cl. F21V 8/00

(52) U.S. Cl. CPC G02B 6/0036

(57) ABSTRACT

Apparatus can comprise a light source and a light guide plate. The light guide plate can comprise a plurality of features within an interior of the light guide plate. A feature of the plurality of features can comprise a first refractive index that is different from a refractive index of the light guide plate. A spacing between a pair of adjacent features of the plurality of features can be from about 20 micrometers to about 200 micrometers. The apparatus can be used to direct light out of the light guide plate with a peak radiance oriented from 0° to 30° from a direction normal to the first major surface of the light guide plate. Methods of making the apparatus can comprise emitting a burst of pulses from a laser. Methods can comprise focusing the burst of pulses into a line focus within the light guide plate.

### CROSS-REFERENCE TO RELATED APPLICATIONS

This application claims the benefit of priority of U.S. Provisional Application Ser. No. 62/790,048 filed on Jan. 9, 2019 and U.S. Provisional Application Ser. No. 62/949,645 filed on Dec. 18, 2019, the contents of which are relied upon and incorporated herein by reference in their entirety as if fully set forth below.

### FIELD

The present disclosure relates generally to apparatus comprising a light guide plate with features and methods for using the same to direct light and, more particularly, to apparatus comprising a light guide plate with internal features as well as methods for using the same to direct light.

### BACKGROUND

It is known to use an apparatus in display devices including liquid crystal displays (LCDs) and the like to light a display. For compactness, such an apparatus often employs a light source that emits into an edge of the light guide plate to propagate light through the light guide plate.

### SUMMARY

The following presents a simplified summary of the disclosure to provide a basic understanding of some embodiments described in the detailed description.

The embodiments of the disclosure can provide for the generation of features internal to the light guide plate. Providing features internal to the light guide plate can increase light extraction because the features can cover a large cross-sectional area of the light guide plate. Providing features internal to the light guide plate can reduce (e.g., decrease) the incidence of damage (e.g., fracture, puncture) to the light guide plate because the surface(s) of the light guide plate are not modified. Providing features internal to the light guide plate can avoid issues associated with coupling between a surface of the light guide plate and another surface because the light guide plate can present a uniform and/or planar surface. Providing features internal to the light guide plate can enable the light guide plate to direct light out of the first major surface with a peak radiance oriented from 0° to 30° from a direction normal to the first major surface. The extraction profile (e.g., peak radiance) can be controlled by adjusting the tilt angle of a feature and/or using different tilt angles in the same light guide plate. Likewise, the extraction profile can be controlled by adjusting an angle between a crack plane relative to the first edge based on a position along the width of the light guide plate.

The embodiments of the disclosure can provide for spacings between an adjacent pair of features of the plurality of features of about 20 μm or more. Providing a small spacing (e.g., about 20 μm) can enable uniform and/or even light extraction and/or the reduction of bright spots of light extracted from the light guide plate. Providing a small spacing can enable a wider range of spacings to be used within a single light guide plate, which can enable more uniform and/or even light extraction across the length of the light guide plate. Such a spacing pattern may provide the technical benefit of evenly distributing light between the feature paths because feature paths are denser at locations farther away from the light source with lower light intensity. In some embodiments, the spacing can comprise the spacing between feature paths, which can decrease as the distance from the light source and/or first edge increases. In some embodiments, the spacing can comprise the spacing between a pair of adjacent features on a common feature path, and the spacing between adjacent pairs of features on a common feature path can decrease as the corresponding feature path's distance from the light source and/or the first edge increases. In some embodiments, a first pair of adjacent features on a first feature path can be staggered relative to a second pair of adjacent features on a second feature path adjacent to the first feature path. Such a staggered design can provide the technical benefit of distributing the light leaving the light guide plate more evenly along the length of the light guide plate than having features aligned between feature paths. Additionally, the evenness and/or uniformity of the light can be increased by having a first feature comprise a first height that is less than a second height of a second feature when the second feature is positioned farther from the first edge and/or light source than the second edge.

The embodiments of the disclosure can provide for increased light extraction per feature. Providing features internal to the light guide plate can cover a large cross-sectional area of the light guide plate. Providing features comprising a slight refractive index difference (e.g., in a range from about 0.0005 to about 0.015) compared to the bulk of the light guide plate can increase refraction of light by the features because less light may be reflected towards the light source. Annealing the light guide plate after generating the plurality of features can produce a feature with a more consistent refractive index profile and/or more consistent features across the plurality of features. Light extraction per feature can be increased by providing features comprising controlled cracking (e.g., comprising a plurality of cracks substantially positioned within about 10° or a corresponding crack plane), as demonstrated by the examples. The light extraction of a feature can be increased by adjusting the tilt angle of the feature based on the distance from the first edge.

The embodiments of the disclosure can provide for features comprising a plurality of cracks. Providing features comprising controlled cracking (e.g., comprising a plurality of cracks substantially positioned within about 10° or a corresponding crack plane) can increase light extraction. Providing features comprising controlled cracking (e.g., using a phase mask) can produce more centered and broader regions of high radiance and moderate radiance. Providing a phase mask can enable the laser beam to focus into a line focus within the light guide plate for the generation of features internal to the light guide plate using a single burst of pulses. Providing a phase mask can enable the generation of consistent and/or reproducible cracking patterns in features. Providing a phase mask comprising a region within a predetermined angle of a phase axis can produce features comprising controlled cracking (e.g., a plurality of cracks substantially positioned within a predetermined angle of a crack plane), which can enable enhanced light extraction and/or broader regions of increased (e.g., high) radiance. Providing a phase mask comprising a non-focusing central portion and/or outer peripheral portion can limit the length of the line focus, which can enable the production of features that are internal to the light guide plate.

In accordance with some embodiments, an apparatus can comprise a light guide plate comprising a first major surface, a second major surface, a first edge extending between the first major surface and the second major surface, and a thickness defined between the first major surface and the second major surface. A plurality of features can be internal to the light guide plate. One or more features of the plurality of features can comprise a first refractive index. One or more features of the plurality of features can comprise a height in a direction of the thickness of the light guide plate. One or more features of the plurality of features can comprise a tilt angle defined between a central axis of a feature of the one or more features and a direction of the thickness of the light guide plate. A spacing between a pair of adjacent features of the plurality of features can be in a range from about 20 micrometers (μm) to about 200 micrometers. The apparatus can further comprise a light source positioned to emit light into the first edge of the light guide plate. A difference between the first refractive index and a refractive index of the light guide plate can be about 0.0005 or more.

In some embodiments, a width of the one or more features can be in a range from about 5 micrometers to about 100 micrometers.

In some embodiments, the first reactive index of the one or more features maybe greater than the refractive index of the light guide plate.

In further embodiments, the one or more features may further comprise a second refractive index. The second refractive index can be less than the refractive index of the light guide plate.

In some embodiments, the difference between the first refractive index of the one or more features and the refractive index of the light guide plate is in a range from about 0.0005 to about 0.015.

In some embodiments, the tilt angle can be in a range from about 20° to about 40°.

In further embodiments, the tilt angle can be in a range from about 25° to about 35°.

In some embodiments, the height of the one or more features may increase as a distance of the one or more features from the first edge increases.

In some embodiments, the height of the one or more features can be in a range from about 5 micrometers to about 3 millimeters.

In further embodiments, a feature of the one or more features can comprise a plurality of cracks extending radially outward from the central axis of the feature.

In even further embodiments, substantially all of the cracks are within 15° of a crack plane comprising the central axis of the feature.

In some embodiments, substantially all of the cracks of the plurality of cracks are within 10° of the crack plane.

In further embodiments, the first and second major surfaces of the light guide plate may comprise a quadrilateral shape. The light guide plate may further comprise a second edge extending between the first and second major surfaces and opposite the first edge. The light guide plate may further comprise a third edge extending between the first and second major surfaces. The light guide plate may further comprise a fourth edge extending between the first and second major surfaces opposite the third edge. A length of the light guide plate can be defined between the first edge and the second edge. A width of the light guide plate can be defined between the third edge and the fourth edge. The light guide plate can comprise a first feature path that may extend from the third edge of the light guide plate to the fourth edge of the light guide plate. The one or more features can comprise a plurality of first features that may be positioned on the first feature path.

In further embodiments, a second feature path and a third feature path may each extend from the third edge of the light guide plate to the fourth edge of the light guide plate. The one or more features can comprise a plurality of second features that may be positioned on the second feature path. The second feature path may be positioned between the first feature path and the third feature path. The first feature path may be positioned closer to the first edge than the second feature path.

In even further embodiments, the first feature path, the second feature path, and the third feature path can each extend substantially parallel to the first edge.

In even further embodiments, the spacing may comprise a first path spacing between the first feature path and the second feature path. The spacing may further comprise a second path spacing between the second feature path and the third feature path. The second path spacing can be less than the first path spacing.

In even further embodiments, the pair of adjacent features can comprise a first pair of adjacent features of the first plurality of features. The first pair of adjacent features can be positioned on the first feature path. The spacing can comprise a first feature spacing along the first feature path between the first pair of adjacent features of the plurality of first features.

In still further embodiments, the pair of adjacent features can comprise a second pair of adjacent features of the second plurality of features. The second pair of adjacent features can be positioned on the second feature path. The spacing can comprise a second feature spacing along the second feature path between the second pair of features of the plurality of second features.

In yet further embodiments, the first pair of adjacent features can be staggered relative to the second pair of adjacent features.

In even further embodiments, a height of a feature of the plurality of second features positioned along the second feature path can be greater than a height of a feature of the plurality of first features positioned along the first feature path.

In even further embodiments, a first tilt angle of the plurality of first features positioned along the first feature path can be greater than a second tilt angle of a feature of the plurality of second features positioned along the second feature path. The first tilt angle and second tilt angle are measured relative to the direction of the thickness of the light guide plate.

In further embodiments, a feature of the plurality of first features can comprise a plurality of cracks extending radially outward from the central axis of the feature. Substantially all of the cracks can be within 15° of a crack plane comprising the central axis of the feature. A crack plane angle can be defined between the crack plane and a tilt plane. The tilt plane can comprise the central axis of the feature and extend in a direction of the width of the light guide plate.

In even further embodiments, the crack plane angle can be in a range from 0° to about 30°.

In even further embodiments, the crack plane angle can be in a range from 0° to about 5°.

In even further embodiments, the plurality of first features can comprise a first outer feature, a second outer feature, and a central feature positioned between the first outer feature and the second outer feature. A magnitude of a crack plane angle of the central feature can be less than a magnitude of a crack plane angle of the first outer feature. The magnitude of the crack plane angle of the central feature can be less than a magnitude of a crack plane angle of the second outer feature.

In accordance with some embodiments, methods are provided for emitting light using any of the embodiments of the apparatus discussed above. Methods may involve injecting light emitted from the light source through the first edge of the light guide plate and into the light guide plate. Also, methods may involve propagating the injected light within the light guide plate. As well, methods may involve passing the light propagating in the light guide plate through the first major surface of the light guide plate with a peak radiance oriented from 0° to 30° from a direction normal to the first major surface of the light guide plate.

In some embodiments, the peak radiance can be oriented from 0° to 25° from a direction normal to the first major surface of the light guide plate.

In accordance with some embodiments, methods of making any of the embodiments of the apparatus described above may comprise emitting a burst of pulses from a laser. The burst of pulses may be generated at a rate in a range from about 10 kilohertz to about 1 megahertz. The burst of pulses can comprise a total energy in a range from about 5 microjoules to about 500 microjoules. Also, methods may involve focusing the burst of pulses into a line focus within the light guide plate. Additionally, methods may involve impinging the burst of pulses on the light guide plate to form a feature of the plurality of features.

In some embodiments, the total energy of the burst of pulses can be in a range from about 10 microjoules to about 100 microjoules.

In some embodiments, the method may further comprise annealing the light guide plate after forming the feature.

In some embodiments, the number of pulses in the burst of pulses can be about 10 or less.

In some embodiments, the focusing can comprise focusing a laser beam of a pulse of the burst of pulses using a phase mask.

In further embodiments, the phase mask may not focus an axis of the laser beam comprising the pulse of the burst of pulses. The axis can intersect a center of the laser beam.

In even further embodiments, the phase mask may not focus a region within at least 5° of the axis measured relative to the center of the laser beam.

In yet further embodiments, the region can comprise 15° from the axis.

In further embodiments, the phase mask may not focus a central portion of the laser beam comprising the pulse of the burst of pulses.

In further embodiments, the phase mask may not focus an outer peripheral portion of the laser beam comprising the pulse of the burst of pulses.

In further embodiments, the phase mask can comprise an elliptical pattern.

In further embodiments, focusing the burst of pulses can comprise reflecting the burst of pulses off of a spatial light modulator comprising the phase mask.

In further embodiments, focusing the burst of pulses can comprise transmitting the burst of pulses through a beam block comprising the phase mask.

In some embodiments, focusing the burst of pulses can comprise transmitting the burst of pulses through an axicon.

In some embodiments, the number of pulses in the burst of pulses can be in a range from about 100 to about 1,500.

### BRIEF DESCRIPTION OF THE DRAWINGS

These and other features, aspects and advantages are better understood when the following detailed description is read with reference to the accompanying drawings, in which:

FIG. 1 illustrates a cross-sectional side view of an example embodiment of an apparatus including a light guide plate with a plurality of features within the light guide plate;

FIG. 2 is an enlarged view 2 of FIG. 1 illustrating a set of features of the plurality of features in accordance with a first example embodiment of the apparatus;

FIG. 3 is an alternative enlarged view 2 of FIG. 1 illustrating a set of features of the plurality of features in accordance with a second example embodiment of the apparatus;

FIG. 4 illustrates a cross-section taken along the line 4-4 in FIG. 2 in accordance with some embodiments of the apparatus;

FIG. 5 illustrates an alternative cross-section taken along the line 4-4 in FIG. 2 in accordance with other embodiments of the apparatus;

FIG. 6 illustrates a plan view taken along the line 6-6 in FIG. 1 showing a first example embodiment of an arrangement of the plurality of features within the light guide plate;

FIG. 7 illustrates another plan view taken along the line 6-6 in FIG. 1 showing a second example embodiment of an arrangement of the plurality of within the light guide plate;

FIG. 8 illustrates another plan view taken along the line 6-6 in FIG. 1 showing a third example embodiment of an arrangement of the plurality of within the light guide plate;

FIG. 9 illustrates the refractive index profile of different portions of a feature of the plurality of features without annealing;

FIG. 10 illustrates the refractive index profile of different portions of a feature of the plurality of features with annealing;

FIG. 11 illustrates the angular distribution of light leaving the first major surface of a light guide plate for features with different tilt angles;

FIG. 12 illustrates the angular distribution of light leaving the first major surface of a light guide plate when there is a reflector at the second edge of the light guide plate and a tilt angle of the plurality of features is 35°;

FIG. 13 illustrates an alternative cross-section taken along the line 4-4 in FIG. 2 in accordance with other embodiments of the apparatus;

FIG. 14 illustrates the angular distribution of light leaving the first major surface of a light guide plate according to some embodiments;

FIG. 15 illustrates the angular distribution of light leaving the first major surface of a light guide plate according to some embodiments;

FIG. 16 illustrates an optical apparatus that can be used in a method of the apparatus in accordance with some embodiments;

FIG. 17 illustrates alternative optical apparatus that can be used in a method of the apparatus in accordance with some embodiments;

FIG. 18 illustrates a phase mask that can be used as part of the optical apparatus in accordance with some embodiments; and

FIG. 19 is an enlarged view 19 of FIG. 16 illustrating a line focus within the light guide plate according to some embodiments.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

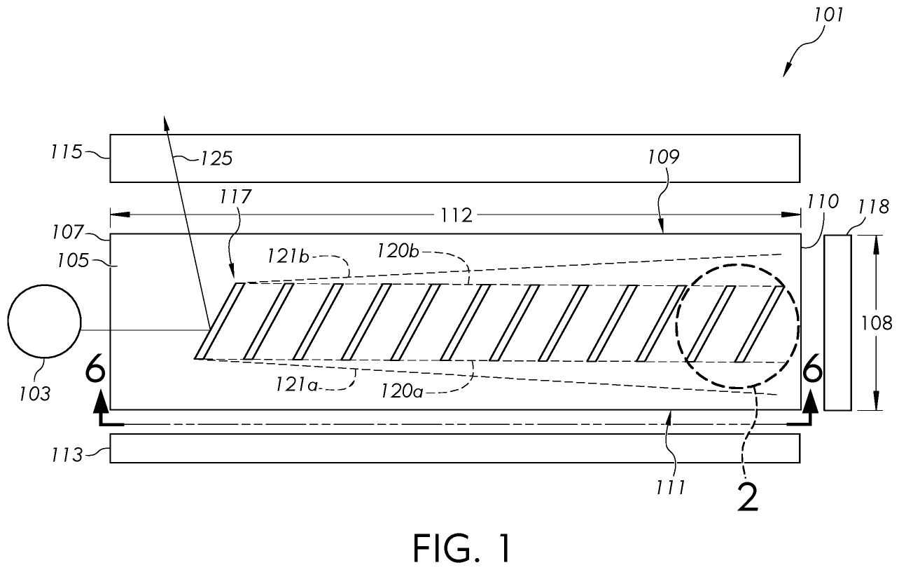

FIG. 1 schematically illustrates a cross-sectional side view of an example embodiment of an apparatus 101. The apparatus 101 can comprise a light guide plate 105 including a first major surface 109 and a second major surface 111 that is opposite the first major surface 109. As shown, the first major surface 109 can extend along a first planar surface and the second major surface 111 can extend along a second planar surface. Although not shown, in other embodiments, the first and second major surfaces 109, 111 may extend along a curved surface. Furthermore, as shown, the first major surface 109 can extend parallel to the second major surface 111, wherein a thickness 108 can be defined between the first major surface 109 and the second major surface 111. As such, the thickness 108 is measured as the shortest distance between the first major surface 109 and the second major surface 111. In some embodiments, as shown in FIG. 1, the thickness will be measured in a direction perpendicular to the first major surface 109 and/or perpendicular to the second major surface 111. In some embodiments, the thickness 108 can be in a range of 100 micrometers (μm) to about 10 millimeters (mm), although other thicknesses may be provided in further embodiments. In some embodiments, the thickness 108 can be about 100 μm or more, about 200 μm or more, about 300 μm or more, about 500 μm or more, about 700 μm or more, about 1 mm or more, about 10 mm or less, about 6 mm or less, or about 3 mm or less. In some embodiments, the thickness 108 can be in a range from about 100 μm to about 10 mm, from about 100 μm to about 6 mm, from about 100 μm to about 3 mm, from about 200 μm to about 10 mm, from about 200 μm to about 6 mm, from about 200 μm to about 3 mm, from about 300 μm to about 6 mm, from about 300 μm to about 3 mm, from about 500 μm to about 3 mm, from about 700 μm to about 3 mm, from about 1 mm to about 3 mm, or any range or subrange therebetween. In embodiments where a small thickness is desirable, the thickness 108 may be about 1 mm or less, about 500 μm or less, or even about 200 μm or less. In further embodiments, the thickness 108 can be in a range from about 200 μm to about 1 mm, from about 200 μm to about 700 μm, from about 300 μm to about 700 μm, or from about 300 μm to about 500 μm, or any range or subrange therebetween. Furthermore, the thickness 108 can be substantially constant along a significant amount of the light guide plate 105 due to the substantially parallel arrangement of the first and second major surfaces 109, 111, as shown. Although not shown, rather than extending parallel to one another, the first major surface 109 and the second major surface 111 may extend at an acute angle relative to one another, wherein the thickness 108 can vary along a length and/or a width of the light guide plate 105.

The first and second major surfaces 109, 111 of the light guide plate 105 can comprise an outer periphery (e.g., perimeter) comprising a wide range of shapes, for example, polygonal with three or more sides (e.g., triangular, quadrilateral), curvilinear (e.g., circular, elliptical) or a shape have a combination of polygonal and curvilinear features. As shown in FIGS. 1 and 6-8, the first major surface 109 and the second major surface 111 of the light guide plate 105 may each comprise a quadrilateral shape (e.g., rectangular shape). In such embodiments, a first edge 107 and a second edge 110 of the light guide plate 105 may each extend between the first major surface 109 and the second major surface 111. The first edge 107 and the second edge 110 can comprise straight edges that are parallel to one another. Furthermore, the second edge 110 may be positioned opposite the first edge 107 to define a length 112 of the light guide plate 105 therebetween. As shown in FIGS. 6-8, the light guide plate 105 may further include a third edge 807 and a fourth edge 809 that can each extend between the first major surface 109 and the second major surface 111. The third edge 807 and the fourth edge 809 can comprise straight edges that are parallel to one another. Furthermore, the fourth edge 809 may be positioned opposite the third edge 807 to define a width 813 of the light guide plate 105 therebetween. As such, the edges 107, 110, 807, 809 can likewise form a rectangular shape with each of the third edge 807 and the fourth edge 809 extending from the first edge 107 to the second edge 110 while being perpendicular to the first and second edges 107, 110. In some embodiments, the length 112 of the light guide plate 105 can be about the same as, greater than, or less than the width 813 of the light guide plate 105. As indicated above, the length can extend in a direction 803 (e.g., a direction of light emitted from the light source 103 going toward the first edge 107) while the width can extend in a direction 802 perpendicular to direction 803. In some embodiments, the length 112 and the width 813 of the light guide plate 105 may be equal to the corresponding measurements of an associated display 115 (see FIG. 1), although other lengths may be provided in further embodiments.

The light guide plate 105 can comprise a wide range of materials that provide desired optical properties. In some embodiments, the light guide plate 105 can comprise an amorphous inorganic material (e.g., glass), a crystalline material (e.g., sapphire, single crystal or polycrystalline alumina, spinel (MgAl₂O₄), quartz), or a polymer. Embodiments of suitable polymers can include, without limitation, the following as well as copolymers and blends thereof: thermoplastics including polystyrene (PS), polycarbonate (PC), polyesters including polyethyleneterephthalate (PET), polyolefins including polyethylene (PE), polyvinylchloride (PVC), acrylic polymers including polymethyl methacrylate (PMMA), thermoplastic urethanes (TPU), polyetherimide (PEI), epoxies, and silicones including polydimethylsiloxane (PDMS). Embodiments of glass, which may be strengthened or non-strengthened and may be free of lithia or not, include soda lime glass, alkali aluminosilicate glass, alkali containing borosilicate glass and alkali aluminoborosilicate glass. As used herein, the term “strengthened” when applied to a substrate, for example glass or another transparent layer, may refer to a substrate that has been chemically strengthened, for example through ion-exchange of larger ions for smaller ions in the surface of the substrate. However, other strengthening methods known in the art, for example thermal tempering, or utilizing a mismatch of the coefficient of thermal expansion between portions of the substrate to create surface compressive stress and central tension regions, may be utilized to form strengthened substrates.

The light guide plate 105 comprises a refractive index. The refractive index of the light guide plate 105 may be a function of a wavelength of light passing through the light guide plate 105. For light of a first wavelength, a refractive index of a material is defined as the ratio between the speed of light in a vacuum and the speed of light in the corresponding material. Without wishing to be bound by theory, a refractive index of the light guide plate 105 can be determined using a ratio of a sine of a first angle to a sine of a second angle, where light of the first wavelength is incident from air on an incident surface of the light guide plate 105 at the first angle and refracts at the incident surface of the light guide plate 105 to propagate within the light guide plate 105 at a second angle. The first angle and the second angle are both measured relative to a normal of the incident surface of the light guide plate 105. In some embodiments, the refractive index of the light guide plate 105 may be about 1 or more, about 1.3 or more, about 1.4 or more, about 3 or less, about 2 or less, or about 1.7 or less. In some embodiments, the first refractive index of the light guide plate 105 can be in a range from about 1 to about 3, from about 1 to about 2 from about 1 to about 1.7, from about 1.3 to about 3, from about 1.3 to about 2, from about 1.3 to about 1.7, from about 1.4 to about 2, from about 1.4 to about 1.7, or any range or subrange therebetween.

With initial reference to FIG. 1, the light guide plate 105 comprises a plurality of features 117 internal to the light guide plate 105. Throughout the disclosure, a feature is internal to a light guide plate if the feature does not comprise nor intersect a first major surface of the light guide plate facing a display, any major surface opposite the first major surface, a first edge facing a light source, or any surface opposite the first edge. For example, with reference to FIGS. 1 and 6-8, the plurality of features 117, 301, 501, 801, 1301 are internal to the light guide plate 105 because they do not comprise nor do they intersect the first major surface 109, the second major surface 111 (shown as opposite the first major surface 109), the first edge 107, or the second edge 110 (shown as opposite the first edge 107) of the light guide plate 105.

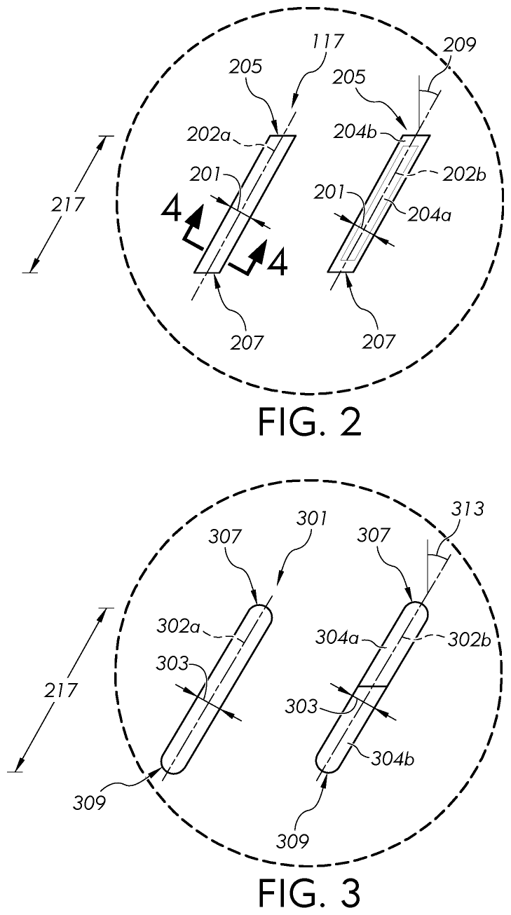

As used herein, the plurality of features 117, 301, 501, 801, 1301 comprise a material of the light guide plate 105 that has been modified using electromagnetic radiation (e.g., emitted from a laser), as described below. The feature 117 will be described below with the understanding that the description can equally apply to the features 301, 501, 801, 1301. The feature can comprise one or more portions comprising a refractive index different from a refractive index of the light guide plate and/or cracks. A feature of the plurality of features 117 comprises a first portion comprising a first refractive index. A differential equal to the absolute value of the difference between the first refractive index of the first portion of a feature of the plurality of features 117 and the refractive index of the light guide plate 105 is at least about 0.0005. In some embodiments, the differential is about 0.0005 or more, about 0.001 or more, about 0.005 or more, about 0.020 or less, about 0.015 or less, or about 0.010 or less. In some embodiments, the differential is in a range from about 0.0005 to about 0.020, from about 0.0005 to about 0.015, from about 0.0005 to about 0.010, from about 0.001 to about 0.020, from about 0.001 to about 0.015, from about 0.001 to about 0.010, from about 0.005 to about 0.020, from about 0.005 to about 0.015, from about 0.005 to about 0.010, or any range or subrange therebetween. In some embodiments, the first refractive index of the first portion of a feature of the plurality of features 117 may be greater than the refractive index of the light guide plate 105. In further embodiments, a feature of the plurality of features 117 may comprise a second portion comprising a second refractive index that can be less than the refractive index of the light guide plate 105 by at least about 0.0005. In even further embodiments, as shown in FIG. 3, the first portion of a feature 301 may comprise a top portion 304a of the feature 301 while the second portion of the corresponding feature 301 may comprise a bottom portion 304b of the corresponding feature 301, where both the first (e.g., top) and second (e.g., bottom) portions 304a, 304b are adjacent to the first material of the light guide plate 105. In other even further embodiments, as shown in FIG. 2, the first portion of a feature 117 may comprise an inner portion 204a of the feature 117 while the second portion of the corresponding feature 117 may comprise an outer portion 204b of the corresponding feature 117, where the second (e.g., outer) portion 204b may be between the first (e.g., inner) portion 204a of the feature 117 and a portion of the light guide plate 105. In still further embodiments, the second (e.g., outer) portion 204b of the feature 117 may extend away from the first (e.g., inner) portion 204a of the feature 117 for a first distance. In some embodiments, the first distance may be about 1 μm or more, about 2 μm or more, about 5 μm or more, about 50 μm or less, about 20 μm or less, or about 10 μm or less. In some embodiments, the first distance may be in a range from about 1 μm to about 50 μm, from about 1 μm to about 20 μm, from about 1 μm to about 10 μm, from about 2 μm to about 50 μm, from about 2 μm to about 20 μm, from about 2 μm to about 10 μm, from about 5 μm to about 50 μm, from about 5 μm to about 20 μm, from about 5 μm to about 10 μm, or any range or subrange therebetween. In still further embodiments, as shown in FIG. 2, the second (e.g., outer) portion 204b of the feature 117 may surround the first (e.g., inner) portion 204a of the feature 117.

Generally, referring to view 2 of FIG. 1, various example embodiments of shapes of a feature of the plurality of features 117 along a side cross-sectional view are illustrated in FIGS. 2-5, in accordance with various embodiments of the apparatus 101. In some embodiments, all the features of the plurality of features may have the same shape along a side cross-sectional view. Alternatively, the shape of one feature of the plurality of features may be different than the shape of another feature of the plurality of features along a common cross-sectional view. For example, embodiments may combine one or more shapes described with respect to one of FIGS. 2-5 with one or more other shapes discussed with respect to another one of FIGS. 2-5.

As shown in FIGS. 2-3, a feature 117, 301 extends along a principal feature axis 202a, 302a. The feature 117, 301 comprises a first end 205, 307 and a second end 207, 309 opposite the first end 205, 307. As used herein, a central axis is the principal feature axis comprising a point located at a center of a cross-section taken parallel to the first major surface, as shown in FIGS. 2-3. Throughout the disclosure, the first end of a feature is defined by the point or set of points of the feature that is closest to the first major surface 109 of the light guide plate 105. For example, with reference to FIG. 2, the first end 205 of the feature 117 is defined by the set of points comprising a surface of the feature 117 that is closest to the first major surface 109 of the light guide plate 105. In some embodiments, as shown in FIG. 2, the first end 205 may comprise a flat surface (e.g., a plane). In some embodiments, as shown in FIG. 3, the first end 307 may comprise a point on the illustrated curved surface that is closest to the first major surface 109. Throughout the disclosure, the second end of a feature is defined by the point or set of points of the feature that is closest to the second major surface 111 of the light guide plate 105. For example, with reference to FIG. 3, the second end 309 of the feature 301 is defined by a point on the illustrated curved surface that is closest to the second major surface 111 of the light guide plate 105. In some embodiments, as shown in FIG. 2, the second end 207 may comprise a flat surface (e.g., a plane).

Throughout the disclosure, a tilt angle of a feature is defined as the angle between a central axis (e.g., principal feature axis) of the feature and a direction of the thickness of the light guide plate that is perpendicular to the first major surface. For example, with reference to FIG. 2, the tilt angle 209 of a feature 117 is defined as the angle between the central axis (e.g., principal feature axis 202a, 202b) of the corresponding feature 117 and a direction of the thickness 108 of the light guide plate 105 (e.g., a direction perpendicular to the first major surface 109 of the light guide plate 105). With reference to FIG. 3, the tilt angle 313 of a feature 117 is defined as the angle between the principal feature axis 302a, 302b of the corresponding feature 301 and a direction of the thickness 108 of the light guide plate 105 (e.g., a direction perpendicular to the first major surface 109 of the light guide plate 105). In some embodiments, the tilt angle 209, 313 (shown in FIGS. 2-3 and 14) may be about 10° or more, about 20° or more, about 25° or more, about 30° or more, about 35° or more, about 55° or less, about 45° or less, or about 40° or less. In some embodiments, the tilt angle of a feature 117, 301, 501, 801, 1301 may be in a range from about 10° to about 55°, from about 20° to about 55°, from about 10° to about 45°, from about 20° to about 45°, from 30° to about 45°, from about 35° to about 45°, or any range or subrange therebetween. In further embodiments, the tilt angle 209, 313 may be in a range from about 20° to about 40° or from about 25° to about 35°.

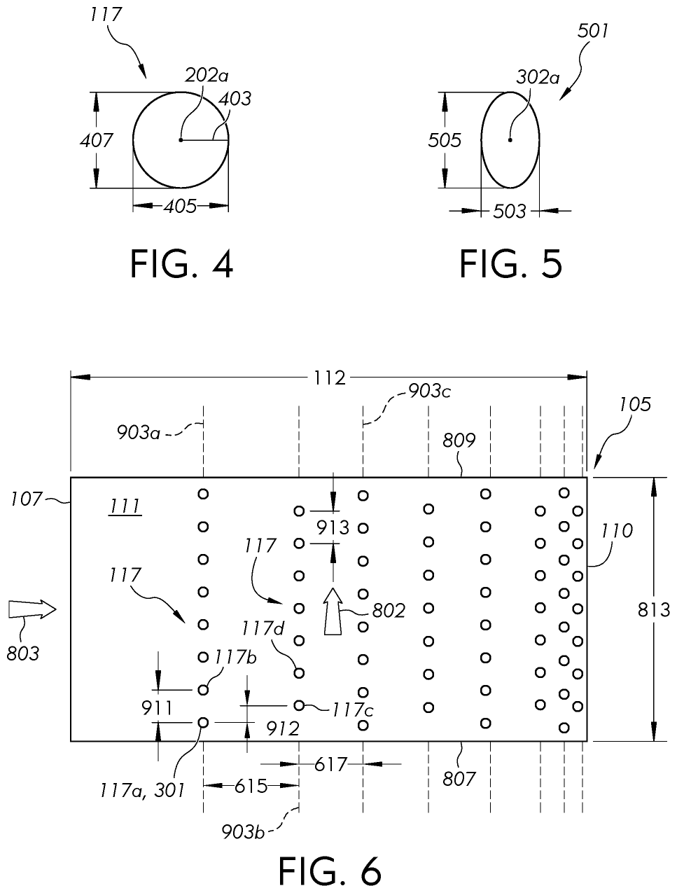

FIGS. 4-5 show different cross-sectional shapes for a feature 117, 501 based on a view taken along the line 4-4 that is perpendicular to the principle feature axis, as shown in FIG. 2. Throughout the disclosure, referring to the cross-sectional shape discussed with respect to line 4-4 above, the width at a location of a feature is defined as the maximum dimension of the cross-sectional shape of the feature at the location of the cross-section in a direction of the length of the light guide plate. For example, with reference to FIG. 4, a first dimension 405 and the second dimension 407 are equal. As shown in FIG. 4, the cross-sectional shape may comprise a circular shape comprising a radius 403 wherein the width is considered the diameter of the circular shape. In some embodiments, as shown in FIG. 5, the cross-sectional shape of the feature may comprise an ellipsoidal shape wherein a first dimension 503 may be less than the second dimension 505 although the first dimension may be greater than the second dimension in further embodiments.

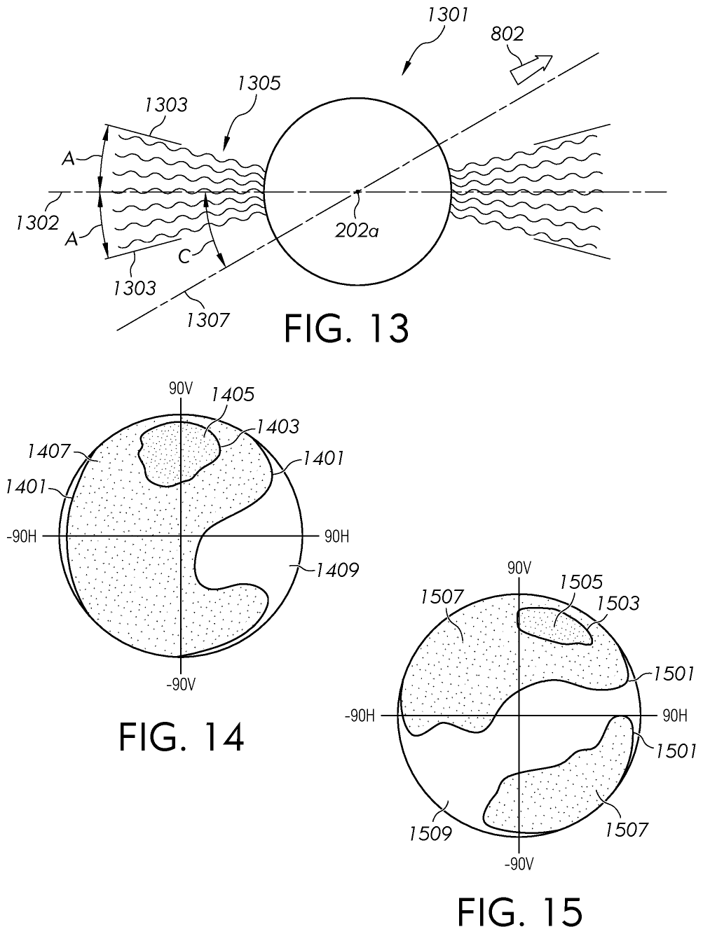

As shown in FIG. 13, in some embodiments, the feature 1301 can also comprise a plurality of cracks 1305. In further embodiments, as shown, one or more cracks of the plurality of cracks 1305 can extend outward in a direction away from the principal feature axis 202a. In even further embodiments, as shown, the plurality of crack 1305 can extend radially outward from a central axis (e.g., principal feature axis 202a) of the feature 1301. In further embodiments, as shown, the plurality of cracks 1305 can be clustered (e.g., positioned around, centered) around a crack plane 1302. As shown, the crack plane 1302 can comprise the central axis (e.g., principal feature axis 202a) of the feature 1301 wherein the principal feature axis 202a is coincident with the crack plane 1302. An angle A can be defined between the crack plane 1302 and an outer limit 1303 of the plurality of cracks 1305 relative to the central axis (e.g., principal feature axis 202a) of the feature 1301. In even further embodiments, as shown, substantially all of the cracks of the plurality of cracks 1305 can be within the outer limits 1303. In still further embodiments 95% or more, 97% or more, or 99% or more of the features can be within the outer limits 1303. In yet further embodiments, all of the cracks of the plurality of cracks 1305 can be within the outer limits 1303. In even further embodiments, the angle A can be about 15° or less, about 10° or less, about 8° or less, about 1° or more, about 2° or more, or about 5° or more. In even further embodiments, the angle A can be in a range from about 1° to about 15°, from about 1° to about 10°, from about 1° to about 8°, from about 1° to about 5°, from about 2° to about 15°, from about 2° to about 10°, from about 2° to about 8°, from about 2° to about 5°, from about 5° to about 15°, from about 5° to about 10°, from about 5° to about 8°, or any range or subrange therebetween. As discussed above, substantially all (e.g., about 95% or more, about 97% or more, about 99% or more, 100%) of the cracks of the plurality of cracks 1305 can be located within an angle A (e.g., 15°, 10°, 8°, 5°) of the crack plane 1302. It is to be understood that the plurality of cracks 1305 discussed with reference to feature 1301 and FIG. 13 can be combined with any of the other features 117, 301, 501, 801 discussed throughout the embodiments of the disclosure.

In some embodiments, as shown in FIG. 13, a crack of the plurality of cracks 1305 can extend for a width in the direction perpendicular to the principal feature axis 202a. In further embodiments, as shown, a crack can be spaced away from the central axis (e.g., principal feature axis 202a). In further embodiments, a crack of the plurality of cracks 1305 can extend for a width from the principal feature axis 202a in the direction perpendicular to the principal feature axis 202a, wherein the width can be about 5 μm or more, about 10 μm or more, about 25 μm more, about 200 μm or less, about 100 μm or less, or about 50 μm or less. In further embodiments, a crack of the plurality of cracks 1305 can extend for a width from the principal feature axis 202a in the direction perpendicular to the principal feature axis 202a, wherein the width can in a range from about 5 μm to about 200 μm, from about 5 μm to about 100 μm, from about 5 μm from about 50 μm, from about 10 μm to about 200 μm, from about 10 μm to about 100 μm, from about 10 μm to about 50 μm, from about 25 μm to about 200 μm, from about 25 μm to about 100 μm, from about 25 μm to about 50 μm or any range or subrange therebetween.

In some embodiments, a crack of the plurality of cracks 1305 can extend for a height in the direction of the height 217 of the feature 1301 (discussed below) that can be about 1% or more, about 25% or more, about 50% or more, about 75% or more, about 99% or more, about 100%, about 99% or less, about 90% or less, or about 75% or less of the height 217 of the feature 117. In further embodiments, a crack of the plurality of cracks 1305 can extend for a height in the direction of the height 217 of the feature 117 (discussed below) that can be, as a percentage of the height 217 of the feature 117, in a range from about 1% to about 99%, from about 1% to about 90%, from about 1% to about 75%, from about 25% to about 99%, from about 25% to about 90%, from about 25% to about 75%, from about 50% to about 99%, from about 50% to about 90%, from about 50% to about 75%, or any range or subrange therebetween.

A feature 117, 301, 501, 801, 1301 comprises a width at every plane perpendicular to the principal feature axis 202a, 202b, 302a, 302b of the corresponding feature 117, 301, 501, 801, 1301. In some embodiments, as shown in FIGS. 2 and 3, the widths 201, 303 (e.g., the dimensions 405, 407 of FIG. 4) of the features 117, 301 can be substantially the same along a central portion of the feature 117, 301 between a first end portion including the first end 205, 307 and a second end portion including the second end 207, 309 of the feature. The width of a feature 117 may fluctuate between the first end 205, 307 and the second end 207, 309. Throughout the disclosure, a maximum width of a feature is defined as the largest value of the width for the feature among the cross sections taken at every plane perpendicular to the principle feature axis from the first end 205, 307 to the second end 207, 309. In some embodiments, the maximum width may be about 5 μm or more, about 20 μm or more, about 200 μm or less or about 100 μm or less. In some embodiments, the maximum width may be in a range from about 5 μm to about 200 μm, from about 5 μm to about 100 μm, from about 20 μm to about 200 μm, from about 20 μm to about 100 μm, or any range or subrange therebetween.

Throughout the disclosure, a height of a feature is defined as the maximum dimension of the feature between a point or set of points at the first end of the feature and a point or set of points at the second end of the feature in a direction of the principal feature axis. For example, with reference to FIG. 2, the height 217 of the feature 117 is defined as the maximum dimension of the feature from the first end 205 (closest to the first major surface 109 of the light guide plate 105) and a point or set of points on the second end 207 (closest to the second major surface 111 of the light guide plate 105) in the direction of the principal feature axis 202a, 202b of the corresponding feature 117. Furthermore, with reference to FIG. 3, the height 217 of the feature 301 is defined as the maximum dimension of the feature from the point on the curved portion of the first end 307 (closest to the first major surface 109 of the light guide plate 105) and the point on the curved portion of the second end 309 (closest to the first major surface 109 of the light guide plate 105) in the direction of the principal feature axis 302a, 302b of the corresponding feature 301. In some embodiments, the height of a feature 117, 301, 501, 801, 1301 may be about 5 μm or more, about 20 μm or more, about 50 μm or more, about 3 mm or less, about 2 mm or less, or about 500 μm or less. In some embodiments, the height of a feature 117, 301, 501, 1301 may be in a range from about 5 μm to about 3 mm, from about 5 μm to about 2 mm, from about 5 μm to about 500 μm, from about 20 μm to about 3 mm, from about 20 μm to about 2 mm, from about 20 μm to about 500 μm, from about 50 μm to about 3 mm, from about 50 μm to about 2 mm, from about 50 μm to about 500 μm, or any range or subrange therebetween.

Referring to FIG. 1, embodiments of the apparatus of any of the embodiments may include a light source 103 that can face the first edge 107 of the light guide plate 105. In some embodiments, the light source 103 can comprise a luminescent light, for example, an array of light emitting diodes (LEDs). In further embodiments, the light source 103 can comprise an incandescent light or an electrical discharge light. The light source 103 can comprise a luminescent diode, a bulb, or a laser. Example diodes can include, without limitation, light emitting diodes (LEDs) comprising inorganic semiconductor materials, small molecule organic light emitting diodes (OLEDs), and polymer light emitting diodes (PLEDs). Examples of bulbs can include, without limitation, incandescent bulbs including tungsten filamented bulbs, gas filed discharge tubes including fluorescent, neon, argon, xenon, and high-energy arc discharge lamps. Examples of lasers can include, without limitation, helium-neon, argon, krypton, ruby, copper vapor, gold vapor, manganese vapor, and dye lasers. In some embodiments, diodes may be used as a light source 103 in embodiments where a compact shape and lower energy consumption are desired. In other embodiments, a fluorescent light source may be used when cost is to be minimized. In further embodiments, the light source 103 can include a light conduit configured to deliver light to the first edge 107 of the light guide plate 105. For instance, the light source 103 can comprise optical fiber(s) to deliver light to the first edge 107.

FIGS. 6-8 schematically illustrate example embodiments of a plan view, taken along the line 6-6 in FIG. 1, showing a direction 803 of light emitted from the light source 103 going toward the first edge 107. In some embodiments, the light source 103 can be positioned to emit light at least partially in a direction 803 perpendicular to the first edge 107, although oblique (i.e., non-perpendicular) directions are possible in further embodiments. As used herein, a distance of a feature 117, 301, 501, 801, 1301 from the first edge 107 of the light guide plate 105 is measured in a direction 803 perpendicular to the first edge 107. Similarly, a distance of a pair of adjacent features from the first edge 107 of the light guide plate 105 is measured in a direction 803 perpendicular to the first edge 107.

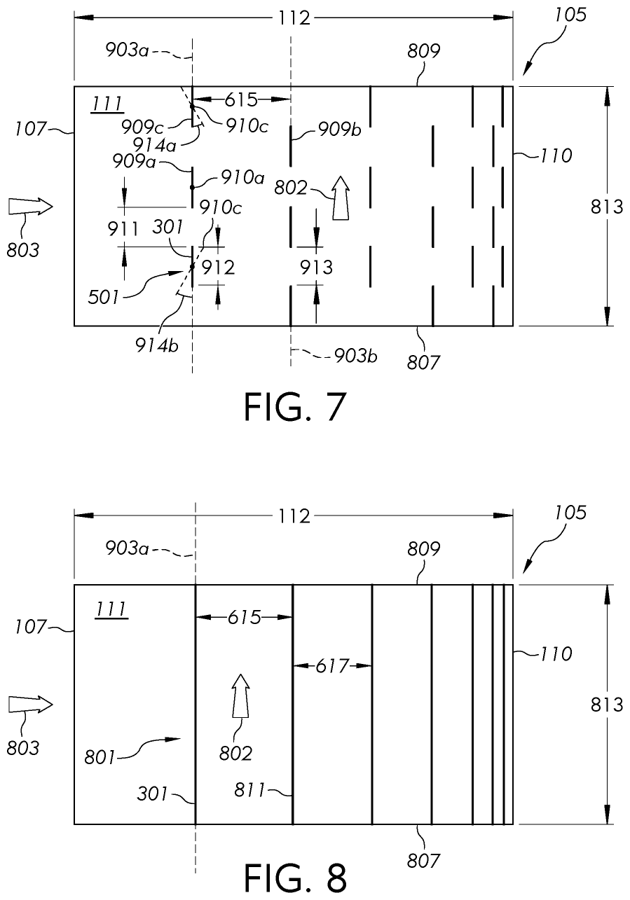

As used herein, an aspect ratio of a feature is defined as a ratio between the second dimension 407, 505 of the end of a feature 117, 301, 501, 801, 1301 and the first dimension of the corresponding end of the corresponding feature 117, 301, 501, 801, 1301, wherein the first dimension is the maximum dimension and the second dimension is the minimum dimension of the cross-section along a plane perpendicular to the principal feature axis. In some embodiments, as shown in FIG. 4 and schematically in FIG. 6, a feature (e.g., 117a) of the plurality of features 117 may have a circular cross-sectional shape (e.g., as shown in FIG. 4) with an aspect ratio of about 1. In other embodiments, as schematically shown in FIG. 7, a feature (e.g., 909a) of the plurality of features 501 may have an ellipsoidal shape (e.g., as shown in FIG. 5), where the second dimension 505 is in a width direction 802 and the aspect ratio is greater than about 1 and less than about 1,000. In still other embodiments, as shown in FIG. 8, a feature (e.g., 801) of the plurality of features 801 with another ellipsoidal shape, where the second dimension 505 is in a width direction 802 and the aspect ratio is greater than 1,000. In further embodiments, as shown in FIG. 8, the second dimension 505 may be substantially equal to the width 813 of the light guide plate 105. In further embodiments, as shown in FIG. 8, the second dimension 505 may be equal to the width 813 of the light guide plate 105 and in the width direction 802 of the light guide plate 105 such that the features 811 pass through both of the third edge 807 and the fourth edge 809. In further embodiments, although not shown, the axis of the second dimension 505 of the cross-section of the features may not extend in the width direction 802 (i.e., the direction of the width 813) of the light guide plate 105. In such examples, the second dimension may be greater or less than the width 813 of the light guide plate 105.

FIG. 7 illustrates an alternative embodiment, where one or more of the features optionally extends through only one of the third edge 807 and the fourth edge 809 and in some embodiments, as shown, extends less than the width 813 of the light guide plate 105. For instance, in embodiments where one or more of the features extends in the direction of the width 813, the second dimension 505 of the features of the plurality of features 117, 301, 501, 801, 1301 may can be in a range from about 10% to about 100%, from about 20% to about 90%, from about 25% to about 75%, from about 10% to about 50%, or from about 15% to about 25% of the width 813 of the light guide plate 105. In some embodiments, the second dimension 505 of the one more features can be about 5 μm or more, about 10 μm or more, about 20 μm or more, about 50 μm or more, about 100 μm or more, about 200 μm or more, or about 500 μm or more, about 1 mm or more, about 10 mm or more, or about 100 mm or more. The second dimension of a feature (e.g., 909a in FIG. 7, 117a in FIG. 6) of the plurality of features 117, 301, 501, 801, 1301 may be the same or different from another feature of the plurality of features 117, 301, 501, 801, 1301. In addition, the shapes of the features of FIGS. 6-8 can comprise the shape of any of the features 117, 301, 501, 801, 1301 or other features, in accordance with the disclosure.

As illustrated in FIGS. 6-8, the light guide plate 105, may comprise at least one feature path 903a, 903b, 903c, etc. As used herein, a feature path is a line with at least one feature on the corresponding feature path. Throughout the disclosure, a feature is considered to be on a feature path when a portion of the corresponding feature is intersected by the feature path. In further embodiments, the principal feature axis 202a, 202b can be intersected by the feature path. In further embodiments, the direction of the width of a feature can be parallel to the feature path. With reference to FIG. 7, a feature 909a is on a feature path 903a because the feature path 903a intersects a portion of the feature 909a. Further, the direction of the width (e.g., second dimension 505) of the feature 909a is parallel to the feature path 903a. Moreover, although not explicitly shown, it appears that the central axis (e.g., principal feature axis 202a, 202b) of feature 909a would be intersected by the feature path 903a.

In some embodiments, a spacing between a pair of adjacent features can comprise a path spacing. Throughout the disclosure, a path spacing is defined as the distance between an adjacent pair of feature paths that are parallel to one another. Referring to FIGS. 6-7, a first path spacing 615 can be defined as the distance between a first feature path 903a and a second feature path 903b that is adjacent the first feature path 903a. In some embodiments, the first path spacing 615 may be about 5 μm or more, about 10 μm or more, about 20 μm or more, about 50 μm or more, or about 100 μm or more. In other further embodiments, the first path spacing 615 may be about 5 mm or less, about 1 mm or less, about 500 μm or less, about 200 μm or less, about 100 μm or less, or about 50 μm or less. In some embodiments, the first path spacing 615 may be in a range from about 5 μm to about 5 mm, from about 5 μm to about 1 mm, from about 5 μm to about 500 μm, from about 5 μm to about 200 μm, from about 10 μm to about 5 mm, from about 10 μm to about 1 mm, from about 10 μm to about 500 μm, or any range or subrange therebetween. Given that, in some embodiments, a small percentage of light may be directed by any single feature of the plurality of features 117, 301, 501, 801, 1301 the first path spacing 615 can be in a range from about 20 μm to about 200 μm, from about 50 μm to about 200 μm, from about 20 μm to about 100 μm, about 50 μm to about 100 μm, or any range or subrange therebetween.

In some embodiments, as shown in FIG. 6, the second feature path 903b may be positioned between the first feature path 903a and a third feature path 903c, where the first feature path 903a is closer to the first edge 107 of the light guide plate 105 than the second feature path 903b. As discussed above, the first path spacing 615 can be defined between the first feature path 903a and the second feature path 903b. As further illustrated, a second path spacing 617 can be defined between the second feature path 903b and the third feature path 903c. In further embodiments, as shown in FIG. 6, the second path spacing 617 may be less than the first path spacing 615. In further embodiments, a first path spacing may be greater than another path spacing when the pair of adjacent feature paths separated by the first path spacing is closer to the first edge 107 of the light guide plate 105 than the pair of adjacent feature paths separated by the other path spacing. Such a path spacing pattern may provide the technical benefit of evenly distributing light between the feature paths because feature paths are denser at locations farther away from the light source 103 with lower light intensity. Without wishing to be bound by theory, light intensity decreases with the inverse square of the distance from a light source in the absence of any objects; in a light guide plate 105, the light intensity may decrease exponentially with distance as light is reflected off of the plurality of features 117 and exits the light guide plate 105. In still further embodiments, this relationship between spacings of pairs of adjacent features can hold for all spacings of adjacent features. In other words, the path spacing 615, 617 between pairs of adjacent features can decrease as a distance of the adjacent pair of features from the first edge 107 of the light guide plate 105 increases. In other embodiments, although not shown, the first path spacing between a first pair of adjacent features can be the same as the second path spacing between a second pair of adjacent features.

In further embodiments, as shown in FIGS. 6-7, feature paths 903a, 903b may be straight and parallel both with respect to one another and with respect to the first edge 107 of the light guide plate 105, as shown. Furthermore, each feature path can comprise a plurality of aligned (e.g., non-staggered, substantially no difference in a position in a direction 802 of the width 813) features, although one or more feature paths may only include a single feature in further embodiments. For instance, FIGS. 6-7 illustrates a first feature path 903a and a second feature path 903b, each feature path including a corresponding plurality of features on the respective feature paths 903a, 903b and are spaced apart from one another along the respective feature paths 903a, 903b. In some embodiments, the spacing between each pair of adjacent features in the first feature path 903a can be the same, although different arrangements may be provided in further embodiments.

In some embodiments, as shown in FIG. 8, there may be only a single feature 301, 801 on a feature path 903a. In other embodiments, as shown in FIGS. 6-7, there may be more than one feature 301, 717a, 117b, 909a, 909c on a feature path 903a, and these features may be referred to as a plurality of first features. In some embodiments, a spacing between a pair of adjacent features can comprise a feature spacing. Throughout the disclosure, a feature spacing is defined as the distance between a pair of adjacent features in the direction of a feature path when both of the features in the adjacent pair of features are on the same, corresponding feature path. For example, with reference to FIG. 7, a first feature spacing 911 is defined between a pair of adjacent features comprising a first pair of adjacent features (e.g., features 301 and 909a), where the first feature spacing 911 is measured in a direction of the feature path 903a since both of the features in the first adjacent pair of features are on the same, corresponding feature path 903a. In further embodiments, as shown in FIG. 7, the distance between all pairs of adjacent features (e.g., 301 and 909a, 909a and 909c) on the same feature path (e.g., feature path 903a) may be substantially equal to the first feature spacing 911 although different distances may be provided in further embodiments.

In some embodiments, as shown in FIG. 7, a second feature spacing 913 defined between a pair of adjacent features comprising a second pair of adjacent features on a second feature path 903b can be the same as the first feature spacing 911 defined above between the first pair of adjacent features on the first feature path 903a, although different distances may be provided in further embodiments. For example, the second feature spacing 913 between the second pair of adjacent features on the second feature path 903b may be less than the first feature spacing 911 between the first pair of adjacent features of the first feature path 903a. As such, the feature spacing can be reduced the farther the pair of adjacent features are positioned relative to the light source 103, which may provide the technical benefit of evenly distributing light along the length of the light guide plate since the pair of adjacent features are spaced closer together at locations farther away from the light source 103 with lower light intensity.

The feature spacings 911, 913 between the pair of adjacent features (e.g. 909a, 909b, 909c) can be about 10 μm or more, about 20 μm or more, about 50 μm or more, or about 100 μm or more. In other further embodiments, the feature spacings 911, 913 between the pair of adjacent features (e.g., 909a, 909b, 909c) can be about 100 mm or less, about 50 mm or less, about 25 mm or less, about 10 mm or less, about 5 mm or less, about 2.5 mm or less, about 1 mm or less, or about 500 μm or less. In some further embodiments, the feature spacings 911, 913 can be in a range from about 10 μm to about 100 mm, in a range from about 10 μm to about 50 mm, from about 10 μm to about 25 mm, from about 10 μm to about 10 mm, from about 10 μm to about 2.5 mm, from about 20 μm to about 2.5 mm, from about 50 μm to about 2.5 mm, from about 100 μm to about 2.5 mm, from about 20 μm to about 1 mm, from about 50 μm to about 1 mm, from about 50 μm to about 500 μm, from about 20 μm to about 200 μm, or any range or subrange therebetween. In even further embodiments, as discussed above, the feature spacings 911, 913 to be in a range from about 20 μm to about 200 μm, from about 20 μm to about 100 μm, from about 50 μm to about 200 μm, from about 50 μm to about 100 μm, or any range or subrange therebetween.

In some embodiments, as shown in FIG. 6, a first pair of adjacent features (e.g., 117a, 117b) of the plurality of first features on the first feature path 903a may be staggered relative to a second pair of adjacent features (e.g., 117c, 117d) of the plurality of second features on the second feature path 903b adjacent to the first feature path 903a. In further embodiments the first pair of adjacent features can be staggered relative to the second pair of adjacent features by a distance 912 in the width direction 802 (i.e., the direction of the width 813) of the light guide plate 105 such that a first feature spacing 911 between the first pair of adjacent features (e.g., 117a, 117b) on the first feature path 903a is not aligned with second feature spacing 913 between the second pair of adjacent features (e.g., 117c, 117d) on the second feature path 903b along a direction 803 of the length 112 of the light guide plate 105 and/or perpendicular to the first edge 107 of the light guide plate 105. Such a staggered design can provide the technical benefit of distributing the light leaving the light guide plate 105 more evenly along the length 112 of the light guide plate 105 than having features 117a, 117c between feature paths 903a, 903b aligned (e.g., non-staggered, substantially no difference in a position in a direction 802 of the width 813). In some further embodiments, as show in FIG. 6, the distance that pairs of adjacent features can be staggered relative to pairs of adjacent features on an adjacent feature paths may be substantially equal to about one or more of the following: half of the first feature spacing 911, half of the second feature spacing 913, or the feature dimension (e.g., 503) in the width direction 802 of the light guide plate 105. In other further embodiments, as shown in FIG. 6, adjacent pairs of features can be staggered relative to another adjacent pair of features on an adjacent feature path by a distance 912 that may be less than either the first feature spacing 911 and/or the second feature spacing 913.

In some embodiments, as shown in FIG. 1 with the dashed lines 120a, 120b, the height 217 (see FIG. 2) of each feature of the plurality of features 117 may be substantially the same. In other embodiments, as shown in FIG. 1 with the dashed lines 121a, 121b, the height of each feature of the plurality of features 117 can increase as the distance from the corresponding feature to the light source 103 increases. In further embodiments, the height of each feature of the plurality of features 117 can increase as the distance from the corresponding feature to the first edge 107 of the light guide plate 105 increases. In further embodiments, the height of a feature positioned on the first feature path can be less than the height of a feature positioned on the second feature path and/or a feature positioned on the third feature path. In other embodiments, the tilt angle of each feature of the plurality of features 117 can change as a function of the distance between the corresponding feature and the first edge 107 of the light guide plate 105. In some further embodiments, the tilt angle may increase as the distance between the corresponding feature and the first edge 107 of the light guide plate 105 increases. In other further embodiments, the tilt angle may decrease as the distance between the corresponding feature and the first edge 107 of the light guide plate 105 increases.

In some embodiments, one or more features of the plurality of features can comprise the crack plane 1302 as discussed above with reference to FIG. 13. Throughout the disclosure, a crack plane angle can be defined between the crack plane and a tilt plane. As used herein, a tilt plane comprises the central axis of a feature wherein the central axis of the feature is coincident with the tilt plane, and the tilt plane extends in a direction of the width of the light guide plate. With reference to FIG. 13, a tilt plane 1307 comprises the central axis (e.g., principal feature axis 202a, 302a) of the feature 1307 and the central axis of the feature is contained within the tilt plane 1307. Furthermore, the tilt plane 1307 extends in a direction 802 of the width 813 of the light guide plate 105 (see FIG. 8). With reference to FIG. 13, a crack plane angle C is defined between the crack plane 1302 and the title plane 1307. In further embodiments, the crack plane angle C can be 0° (i.e., wherein the crack plane 1302 is coincident with the tilt plane 1307). In further embodiments, the crack plane angle C can be greater than 0°, about 2° or more, about 5° or more, about 45° or less, about 30° or less, about 20° or less, about 10° or less, or about 5° or less. In further embodiments, the crack plane angle can be in a range from 0° to about 45°, from about 0° to about 30°, from 0° to about 20°, from 0° to about 10°, from 0° to about 5°, from about 2° to about 45°, from about 2° to about 30°, from about 2° to about 20°, from about 2° to about 10°, from about 2° to about 5°, from about 5° to about 45°, from about 5° to about 30°, from about 5° to about 20°, from about 5° to about 10°, or any range or subrange therebetween.

In further embodiments, as schematically shown in FIG. 7, the plurality of first features positioned on the first feature path 903a can comprise a first outer feature 301, a second outer feature 909c, and a central feature 909b positioned between the first outer feature 301 and the second outer feature 909c along the first feature path 903a. In even further embodiments, the first outer feature 301 can comprise a plurality of cracks substantially within an angle A of a first crack plane 910c, and a first crack plane angle 914b defined between the first crack plane 910c and a tilt plane (shown coextensive with the first outer feature 301 and the first feature path 903a). In even further embodiments, the second outer feature 909c can comprise a plurality of cracks substantially within an angle A of a second crack plane 910c, and a second crack plane angle 914a defined between the second crack plane 910a and a second tilt plane (shown coextensive with the second outer feature 909c and the first feature path 903a). In even further embodiments, the central feature 909b can comprise a plurality of cracks substantially within an angle A of a third crack plane (shown coextensive with the central feature 909a), and a third crack plane angle (shown as 0°) defined between the third crack plane and a central tilt plane of the central feature (shown coextensive with the central feature 909a and the first feature path 903a). In still further embodiments, a magnitude of the first crack plane angle 914b of the first outer feature 301 can be greater than a magnitude of the third crack plane angle of the central feature 909b, and/or a magnitude of the second crack plane angle 914a of the second outer feature 909c can be greater than a magnitude of the third crack plane angle of the central feature 909b. As used herein, a magnitude of an angle means the absolute value of the angle. In still further embodiments, the first crack plane angle 914b of the first outer feature 301 can be greater than the third crack plane angle of the central feature 909b and/or the second crack plane angle 914a of the second outer feature 909c can be greater than the third crack plane angle of the central feature 909b. In still further embodiments, the first crack plane angle 914b of the first outer feature 301 can be substantially equal to the second crack plane angle 914a of the second outer feature 909c. In even further embodiments, the crack plane angles of the features comprising a plurality of cracks substantially within an angle A of a crack plane can be substantially the same.

Referring back to FIG. 1, in some embodiments, the apparatus 101 may optionally further comprise a display 115. In such embodiments, the display 115 may be a liquid crystal display (LCD) or a similar display that may benefit from external illumination. As further illustrated in FIG. 1, in some embodiments, the display 115 may comprise a reflector 113. In such embodiments, the reflector 113 can comprise a material that is inherently reflective, for example, aluminum, steel, or silver. In other such embodiments, the reflector 113 can comprise a material, for example, polyethyleneterephthalate (PET) or polycarbonate (PC) that is reflective when placed adjacent to another material in the apparatus 101 having a different refractive index. In some embodiments, the reflector 113 may comprise an average reflectance over a wavelength range from about 400 nm to about 700 nm of about 90% or more, about 95% or more, about 96% or more, or about 98% or more. In some embodiments, the reflector 113 can face the second major surface 111 of the light guide plate 105, as shown in FIG. 1. In further embodiments, side reflector 118 may face the second edge 110 of the light guide plate 105, as shown in FIG. 1.

As configured in FIG. 1, the display 115 can be backlit by light exiting the light guide plate 105 from the light source 103. In other embodiments, the light guide plate 105 may be on the other side of the display 115 to frontlight the display 115. Also, the light source 103 is shown as facing the first edge 107 of the light guide plate 105 so that the light guide plate 105 is edgelit. In other embodiments, the light source 103 may face another edge (e.g., the second, third and/or fourth edge 110, 807, 809) of the light guide plate 105.

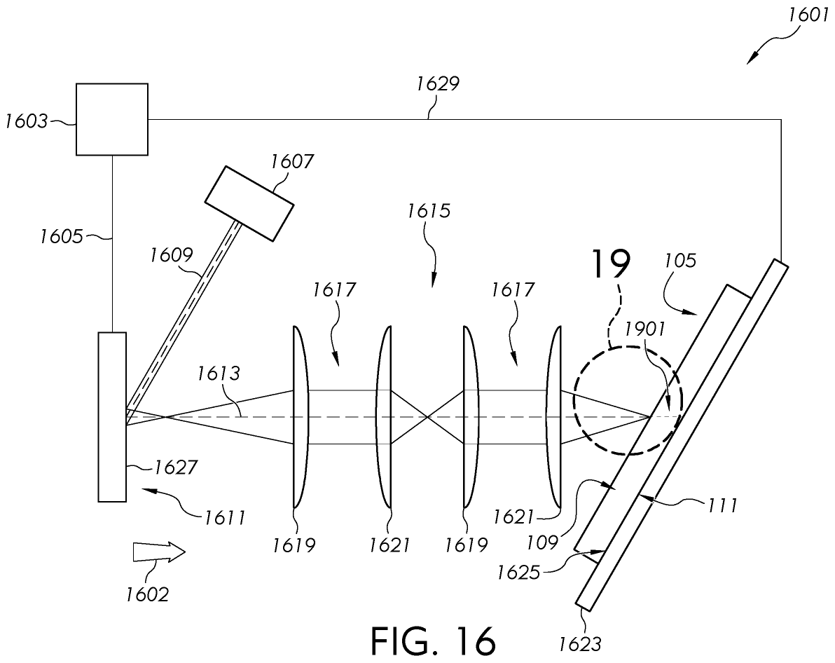

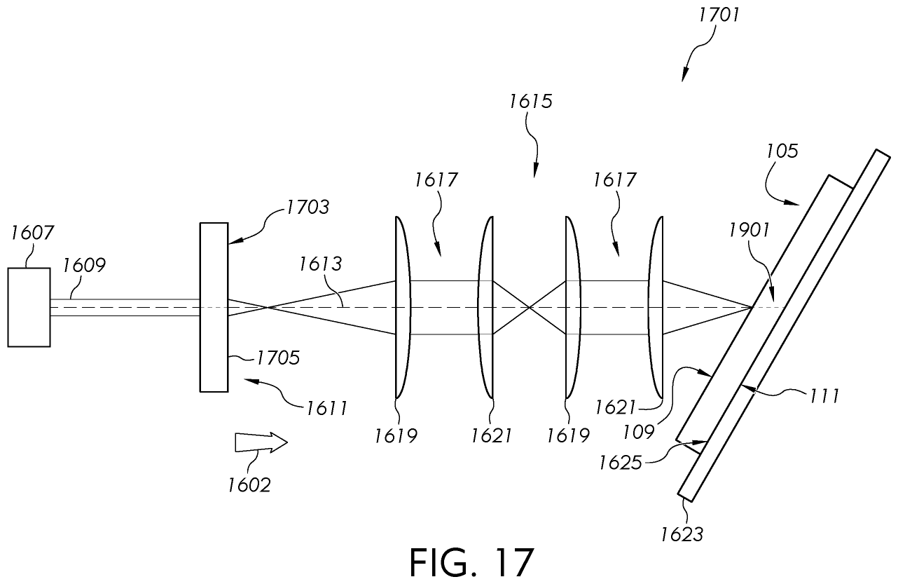

In some embodiments, an optical apparatus 1601, 1701 can be used in a method of making features of the embodiments of the disclosure. Referring now to FIGS. 16-17, an optical apparatus 1601, 1701 for producing the laser beam 1609 that is phase modified such that it forms a line focus 1901 (see FIG. 19) within the light guide plate 105 and has a quasi-non-diffracting character in the light guide plate 105 using the phase-altering optical element 1611 is schematically depicted. The optical apparatus 1601, 1701 can include the laser 1607 that outputs the laser beam 1609, the phase-altering optical element 1611, and, in some embodiments, a lens assembly 1615. The laser 1607 may be configured to output laser beams 1609, for example, pulsed laser beams or continuous wave laser beams. In some embodiments, the laser 1607 may output a laser beam 1609 comprising a wavelength of, for example, 1064 nanometers (nm), 1030 nm, 532 nm, 530 nm, 355 nm, 343 nm, or 266 nm, or 215 nm. The laser beam 1609 used to form features 117 in the light guide plate 105 may be well suited for materials that are transparent to the selected laser wavelength and the light guide plate 105 may be positioned such that the laser beam 1609 output by the laser 1607 irradiates the light guide plate 105, for example, after impinging on the phase-altering optical element 1611 and thereafter, the lens assembly 1615. Further, the beam path 1613 may extend from the laser 1607 to the light guide plate 105 such that when the laser 1607 outputs the laser beam 1609, laser beam 1609 traverses (or propagates along) the beam path 1613. In further embodiments, the laser 1607 can comprise a gas laser, an excimer laser, a dye laser, or a solid-state laser. Example embodiments of gas lasers include helium, neon, argon, krypton, xenon, helium-neon (HeNe), xenon-neon (XeNe), carbon dioxide (CO₂), carbon monoxide (CO), coper (Cu) vapor, gold (Au) vapor, cadmium (Cd) vapor, ammonia, hydrogen fluoride (HF), and deuterium fluoride (DF). Example embodiments of excimer lasers include chlorine, fluorine, iodine, or dinitrogen oxide (N₂O) in an inert environment comprising argon (Ar), krypton (Kr), xenon (Xe), or a combination thereof. Example embodiments of dye lasers include those using organic dyes, for example, rhodamine, fluorescein, coumarin, stilbene, umbelliferone, tetracene, or malachite green dissolved in a liquid solvent. Example embodiments of solid-state lasers include crystal lasers, fiber lasers, and laser diodes. Crystal-based lasers comprise a host crystal doped with a lanthanide, or a transition metal. Example embodiments of host crystals include yttrium aluminum garnet (YAG), yttrium lithium fluoride (YLF), yttrium othoaluminate (YAL), yttrium scandium gallium garnet (YSSG), lithium aluminum hexafluoride (LiSAF), lithium calcium aluminum hexafluoride (LiCAF), zinc selenium (ZnSe), zinc sulfide (ZnS), ruby, forsterite, and sapphire. Example embodiments of dopants include neodymium (Nd), titanium (Ti), chromium (Cr), cobalt (Co), iron (Fe), erbium (Er), holmium (Ho), thulium (Tm), ytterbium (Yb), dysprosium (Dy), cerium (Ce), gadolinium (Gd), samarium (Sm), and terbium (Tb). Example embodiments of solid crystals include ruby, alexandrite, chromium fluoride, forsterite, lithium fluoride (LiF), sodium chloride (NaCl), potassium chloride (KCl), and rubidium chloride (RbCl). Laser diodes can comprise heterojunction or PIN diodes with three or more materials for the respective p-type, intrinsic, and n-type semiconductor layers. Example embodiments of laser diodes include AlGaInP, AlGaAs, InGaN, InGaAs, InGaAsP, InGaAsN, InGaAsNSb, GaInP, GaAlAs, GaInAsSb, and lead (Pb) salts. Some laser diodes can represent exemplary embodiments because of their size, tunable output power, and ability to operate at room temperature (i.e., about 20° C. to about 25° C.).

In the embodiment depicted in FIGS. 16-17, the lens assembly 1615 can comprise two sets of lenses, each set comprising the first lens 1619 positioned upstream of the second lens 1621. The first lens 1619 may collimate the laser beam 1609 within a collimation space 1617 between the first lens 1619 and the second lens 1621 and the second lens 1621 may focus the laser beam 1609. Further, the most downstream positioned second lens 1621 of the lens assembly 1615 may focus the laser beam 1609 into the light guide plate 105, which may be positioned at an imaging plane of this second lens 1621. In some embodiments, the first lens 1619 and the second lens 1621 may each comprise plano-convex lenses. When the first lens 1619 and the second lens 1621 each comprise plano-convex lenses, the curvature of the first lens 1619 and the second lens 1621 may each be oriented toward the collimation space 1617. In other embodiments, the first lens 1619 may comprise other collimating lenses and the second lens 1621 may comprise a meniscus lens, an aspherical lens, or another higher-order corrected focusing lens. In operation, the lens assembly 1615 may control the position of the line focus 1901 along the beam path 1613. Further, the lens assembly 1615 may comprise an 8F lens assembly, as depicted in FIGS. 16-17, a 4F lens assembly comprising a single set of first and second lenses 1619, 1621, or any other known or yet to be developed lens assembly 1615 for focusing the laser beam 1609 into the line focus 1901 and/or along the beam path 1613. Moreover, it should be understood that some embodiments may not include the lens assembly 1615 and instead, the phase-altering optical element 1611 may focus the laser beam 1609 into the line focus 1901.

Referring still to FIGS. 16-17, the phase-altering optical element 1611 can be positioned within the beam path 1613 between the laser 1607 and the light guide plate 105, in particular, between the laser 1607 and the lens assembly 1615 such that the laser beam 1609 impinges on the phase-altering optical element 1611 before the laser beam 1609 is focused into the line focus 1901 and directed into the light guide plate 105. In some embodiments, as shown in FIG. 16, the optical apparatus 1601 can be configured such that the laser 1607 is positioned such that the beam path 1613 is redirected by the phase-altering optical element 1611 and the laser beam 1609 reflects off the phase-altering optical element 1611 when the laser beam 1609 impinges on the phase-altering optical element 1611. In further embodiments, the phase-altering optical element 1611 may comprise an adaptive phase-altering optical element 1627, for example, a spatial light modulator (SLM), a deformable mirror, an adaptive phase plate (ADP), or any other optical element configured to be actively altered to control a change in phase applied by the optical element to the laser beam 1609. In even further embodiments, the SLM can be optically controlled and/or digitally controlled. In some embodiments, as shown in FIG. 17, the optical apparatus 1701 can be configured such that the laser 1607 is positioned such that the beam path 1613 extends through the phase-altering optical element 1611 and the laser beam 1609 traverses the phase-altering optical element 1611 when the laser beam 1609 impinges on the phase-altering optical element 1611. In further embodiments, the phase-altering optical element 1611 may comprise a static phase-altering optical element 1703, for example, an aspheric optical element or a static phase plate. An exemplary embodiment of an aspheric optical element is an axicon 1705 (e.g., elliptical axicon, oblong axicon). An exemplary embodiment of a static phase plate is a beam block, which can comprise portions that block (e.g., reflect) a portion of the laser beam 1609 while comprising portions that focus and/or alter the phase of the laser beam 1609. Thus, in some embodiments, the phase-altering optical element 1611 can be a refractive optical element and in other embodiments, the phase-altering optical element 1611 can be a reflective optical element. In operation, impinging on the laser beam 1609 on the phase-altering optical element 1611 alters the phase of the laser beam 1609 and when directed into the light guide plate 105, a portion of the laser beam 1609 comprising the line focus 1901 within the light guide plate 105 can comprise a different angle within the light guide plate 1905 than the angle of the beam path 1613 through the lens assembly due to differences in the index of refraction between the material of the light guide plate 105 and the medium that the beam path 1613 travels through. For simplicity, the angle of the line focus 1901 and the beam path 1613 are shown as the same with the understanding that the angles may be different in practice.

Without wishing to be bound by theory, after the laser beam 1609 has been phase modified by the phase-altering optical element 1611, the laser beam 1609 can be aberrated when the laser beam is upstream from the light guide plate 105, for example, when the laser beam 1609 is in free space, and the laser beam 1609 is aberrated when the laser beam 1609 is incident on the first major surface 109 of the light guide plate 105. Once refracted at the first major surface 109 of the light guide plate 105, the laser beam 1609 can exhibit a quasi-non-diffracting character and thus has minimal to no aberrations within the light guide plate 105. Without wishing to be bound by theory, the conversion from an aberrated beam to a non-aberrated beam at the first major surface 109 of the light guide plate 105 can be accompanied by an increase in Rayleigh range, which may increase with increasing deviation of the angle of incidence. Without wishing to be bound by theory, the laser beam 1609 may comprise a higher Rayleigh range within the light guide plate 105 than in free space or in positions upstream or incident to the first major surface 109. For example, the Rayleigh range of the laser beam 1609 within the light guide plate 105 may be 10 to 1000 times greater than the Rayleigh range outside (e.g. upstream) the light guide plate 105. For example, after phase modification, the laser beam 1609 outside (e.g. upstream) the light guide plate 105 may comprise a Rayleigh range of 30 μm and the Rayleigh range of the laser beam 1609 within the light guide plate 105 may be 1 mm. Indeed, in some embodiments, the laser beam 1609 can be refracted at the first major surface 109 of the light guide plate 105. The refracting can increase the dimensionless divergence factor FD of a Rayleigh range ZR of the laser beam 1609 by a factor of at least 10, for example, from 10 to 1000, from 10 to 500 from 10 to 100, or the like.

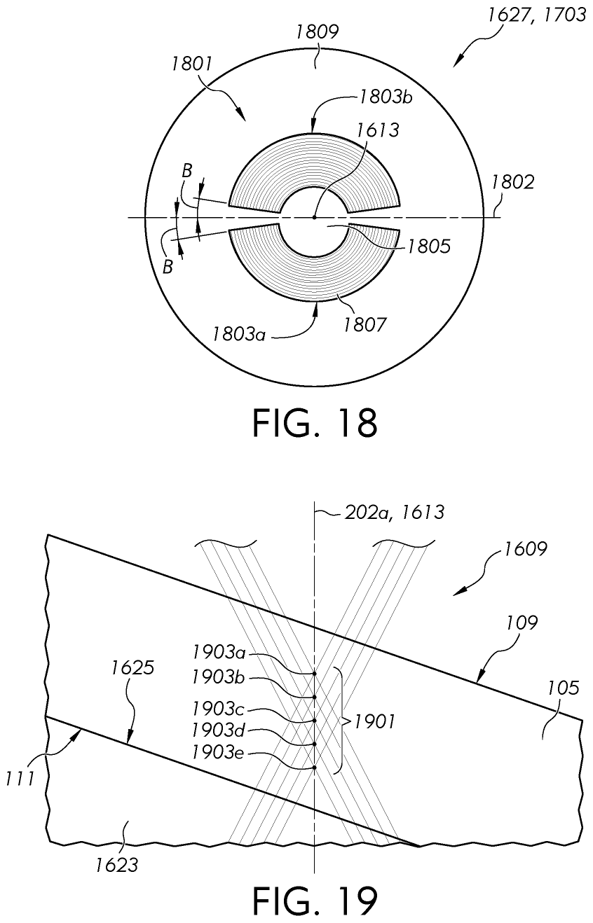

FIG. 18 depicts a phase mask 1801 that may be used by the adaptive phase-altering optical element 1627 and/or the static phase-altering optical element 1703 to alter the phase of the laser beam 1609. In some embodiments, as shown in FIG. 18, the phase mask 1801 of the laser beam 1609 can comprise a plurality of phase rings 1807, each phase ring inducing a phase shift extending from 0 to 2π. In further embodiments, a phase ring of the plurality of phase rings 1807 can comprise an elliptical shape. In further embodiments, as shown, each phase ring of the plurality of phase rings 1807 can comprise an elliptical shape. As such, the phase mask 1801 can comprise an elliptical pattern by comprising phase rings 1807 comprising an elliptical shape. For example, a cross-section of a phase ring of the plurality of phase rings 1807 can comprise an elliptical shape if it comprises an axis of symmetry extending from a first axis end having a first radius of curvature to a second axis end having a second radius of curvature, where the first radius of curvature is different than the second radius of curvature. The minor axis of each phase ring 1807 of the phase mask 1801 can be coincident with the axis of symmetry of each phase ring 1807. With reference to FIG. 18 for the cross-section of the phase rings shows, at least a portion of a phase ring of the plurality of phase rings 1807 comprises an elliptical shape. In some embodiments, the phase ring can comprise a first portion (e.g., located in first portion 1803a) comprising a first elliptical shape defined by a first major axis (e.g., oriented along crack plane 1802) and a first minor axis perpendicular to the first major axis. In further embodiments, the phase ring can comprise a second portion (e.g., located in second portion 1830b) comprising a second elliptical shape defined by the first major axis and a second minor axis. In even further embodiments, the first minor axis can be longer than the second minor axis. In even further embodiments, the second minor axis can be longer than the first minor axis. Providing a phase mask comprising a phase ring comprising two different elliptical shapes can reduce aberrations of a laser beam and/or an associated line focus. In even further embodiments, the second minor axis of substantially equal length to the first minor axis.

In further embodiments, as shown, the phase mask can comprise a first portion 1803a comprising the plurality of phase rings 1807 and a second portion 1803b comprising the plurality of phase rings 1807. As used herein, a portion of the phase mask not comprising phase rings is not configured to focus a laser beam into a line focus. In even further embodiments, as shown, a phase axis 1802 may intersect the phase mask 1801, and the phase axis may be positioned between the first portion 1803a and the second portion 1803b. In still further embodiments, the phase axis 1801 can intersect a center of the phase mask 1801 comprising the beam path 1613 and configured to comprise a center of the laser beam 1609. In yet further embodiments, as shown, the phase mask 1801 may not be configured to focus a portion of the laser beam 1609 impinging on the phase axis 1802. In yet further embodiments, as shown, the phase mask 1801 may not be configured to focus a portion of the laser beam 1609 impinging on the phase mask 1801 within an angle B of the phase axis 1802 relative to the center of the phase mask 1801 comprising the beam path 1613 and configured to comprise a center of the laser beam 1609. In still yet further embodiments, the angle B can be about 1° or more, about 2° or more, about 5° or more, about 10° or more, about 12° or more, about 25° or less, about 15° or less, about 12° or less, or about 10° or less. In still yet further embodiments, the angle B can be in a range from about 1° to about 25°, from about 1° to about 15°, from about 1° to about 12°, from about 1° to about 10°, from about 2° to about 25°, from about 2° to about 15°, from about 2° to about 12°, from about 2° to about 10°, from about 5° to about 25°, from about 5° to about 15°, from about 5° to about 12°, from about 5° to about 10°, from about 10° to about 25°, from about 10° to about 15°, from about 10° to about 12°, or any range or subrange therebetween. In still yet further embodiments, the angle B can be at least 5°, meaning that the phase mask 1801 may not focus a region within at least 5° of the phase axis 1802. In even further embodiments, as shown, the phase mask 1801 may comprise a central portion 1805 configured not to focus a portion of the laser beam 1609 intersecting the central portion 1805 of the phase mask 1801. In even further embodiments, as shown, the phase mask 1801 may comprise an outer peripheral portion 1809 configured not to focus a portion of the laser beam 1609 intersecting the outer peripheral portion 1809 of the phase mask 1801. It is to be understood that the aspects of the phase mask 1801 described above can be combined and that the phase mask may, in some embodiments, resemble the phase mask 1801 shown in FIG. 18. Providing a phase mask can enable the laser beam to focus into a line focus within the light guide plate for the generation of features internal to the light guide plate using a single burst of pulses. Providing a phase mask comprising a region within an angle B of a phase axis can produce features comprising controlled cracking (e.g., a plurality of cracks substantially positioned within an angle A of a crack plane), which can enable enhanced light extraction and/or broader regions of increased (e.g., high) radiance. Providing a phase mask comprising a non-focusing central portion and/or outer peripheral portion can limit the length of the line focus, which can enable the production of features that are internal to the light guide plate.

Referring again to FIG. 16, in some embodiments, the phase-altering optical element 1611 may comprise an adaptive phase-altering optical element 1627, which can apply a phase alteration to the laser beam 1609 using a phase mask 1801. The adaptive phase-altering optical element 1627 may be communicatively coupled to a controller 1603, for example, using one or more communications pathways 1605, which may comprise any pathway for providing power signals, control signals, or the like, for example, optical fiber, electrical wire, wireless protocols, or the like. In operation, the controller 1603 may provide control signals to the adaptive phase-altering optical element 1627 to control the specific phase alteration (e.g., modulation, phase mask, or the like) applied by the adaptive phase-altering optical element 1627 such that the adaptive phase-altering optical element 1627 applies a specific phase alteration to the laser beam 1609, for example, based on a phase function. In some embodiments, the adaptive phase-altering optical element 1627 can comprise a spatial light modulator (SLM), which is a transmissive or reflective device that may spatially modulate the amplitude and/or the phase of a laser beam 1609 in at least one dimension, for example, using a phase mask, for example, the phase mask 1801 of FIG. 18. In operation, the spatial light modulator (SLM) may apply a selective, configurable phase alteration to the laser beam 1609 based on control signals from the controller 1603. In some embodiments, the adaptive phase-altering optical element 1627 can comprise a deformable mirror, which is a mirror whose surface can be deformed in response to control signals, for example, control signals from the controller 1603, to alter the wavefront of the laser beam 1609, which may alter the phase of the laser beam 1609. For example, a deformable mirror may be configured to apply a phase mask, for example, the phase mask 1801. Further, in some embodiments, the adaptive phase-altering optical element 1627 can comprise an adaptive phase plate, which is a phase plate (or phase plate assembly) that can apply selective and controllable phase alteration to the laser beam 1609 in response to control signals, for example, control signals from the controller 1603. For example, the adaptive phase plate may be two or more phase plates moveable relative to one another (e.g., based on control signals from the controller 1603) to alter the phase change they apply to the laser beam 1609 based on their relative positioning.

As shown in FIG. 17, in some embodiments, the phase-altering optical element 1611 can comprise a static phase-altering optical element 1703, for example, an axicon 1705 (e.g., elliptical axicon, oblong axicon). In further embodiments, the axicon 1705 can comprise the phase mask 1801. While a single phase-altering optical element 1611 is depicted in FIGS. 16-17, other embodiments may comprise multiple phase-altering optical elements 1611, for example, one phase-altering optical element configured to transform the laser beam 1609 into a quasi-non-diffracting beam and another phase-altering optical element. In further embodiments, a beam block comprising the phase mask 1801 can be configured to transform the laser beam 1609.

In some embodiments, as shown in FIGS. 16-17 and 19, the laser beam 1609 traveling along the beam path 1613 can impinge on the light guide plate 105. In further embodiments, as shown, the light guide plate 105 can be positioned such that the second major surface 111 of the light guide plate faces (e.g., contacts) a contact surface 1625 of a stage 1623. In even further embodiments, stage 1623 can be translatable and/or rotatable, and the stage 1623 can be adjusted by the controller 1603, for example, using one or more communications pathways 1629. In further embodiments, as shown in FIG. 19, the laser beam 1609 can comprise a line focus 1901 within the light guide plate 105. The schematically shown ray-tracing in FIG. 19 indicates that rays converge at a plurality of focal points 1903a-e positioned along the principal feature axis 202a. As used herein, the extent (e.g., length) of a line focus is the distance comprising the plurality of focal points 1903a-e. In even further embodiments, the line focus 1901 can be limited to a region internal to the light guide plate 105 corresponding to a region for a corresponding feature 117, 301, 501, 801, 1301 internal to the light guide plate 105 being generated (e.g., written).

Features based on the embodiments of the current disclosure can be generated using a laser, for example writing and/or using the optical apparatus 1601, 1701 described above. In some embodiments, the features can be generated using a laser 1607, a lens (e.g., first lens 1619, second lens 1621), and a light guide plate 105. In some embodiments, methods can comprise emitting a burst of pulses from the laser 1607. As used herein, the total energy of a burst of pulses is the sum of the energy of each pulse in the burst of pulses. The burst of pulses can comprise a total energy in a range from about 5 microjoules (μJ) to about 500 μJ, from about 5 μJ to about 200 μJ, from about 5 μJ to about 100 μJ, from about 10 μJ to about 500 μJ, from about 10 μJ to about 200 μJ, from about 10 μJ to about 100 μJ, from about 20 μJ to about 500 μJ, from about 20 μJ to about 200 μJ, from about 20 μJ to about 100 μJ, or any range or subrange therebetween. The pulses of the burst of pulses can be separated by a time in a range from about 0.5 nanoseconds (ns) to about 100 ns, from about 0.5 ns to about 50 ns, from about 0.5 ns to about 20 ns, from about 2 ns to about 100 ns, from about 2 ns to about 50 ns, from about 2 ns to about 20 ns, from about 5 ns to about 100 ns, from about 5 ns to about 50 ns, from about 5 ns to about 20 ns, or any range or subrange therebetween. Bursts each comprising a burst of one or more pulses can be generated at a range in a range from about 10 kilohertz (kHz) to about 1 megahertz (MHz), from about 10 kHz to about 500 kHz, 50 kHz to about 1 MHz, from about 50 kHz to about 500 kHz, from about 100 kHz to about 500 kHz, from about 100 kHz to about 200 kHz, or any range or subrange therebetween. In some embodiments, the number of pulses in the burst of pulses can be about 20 or less or about 10 or less, for example in a range from 1 to 10, 1 to 5, 1 to 3, 3 to 10, 3 to 5, or any range or subrange therebetween. In some embodiments, number pulses in the burst of pulses can be in a range from about 100 to about 1,500, from about 100 to about 1,000, from about 100 to about 800, from about 300 to about 1,500, from about 300 to about 1,000, from about 300 to about 800, from about 600 to about 1,500, from about 600 to about 1,000, from about 600 to about 800, or any range or subrange therebetween.

In some embodiments, methods can comprise focusing the burst of pulses into a line focus 1901 within the light guide plate 105. In further embodiments, focusing the burst of pulses can comprise focusing a laser beam 1609 of a pulse of the burst of pulses using a phase mask 1801. As discussed above, in even further embodiments, the phase mask 1801 can comprise an elliptical pattern (e.g., elliptical phase rings). In even further embodiments, the phase mask 1801 may not focus a central portion of the laser beam 1609 comprising a pulse of the burst of pulses. In even further embodiments, the phase mask 1801 may not focus an outer peripheral portion of the laser beam 1609 comprising a pulse of the burst of pulses. In even further embodiments, the phase mask 1801 may not focus an axis 1802 of the laser beam 1609 intersecting the center of the laser beam 1609. In still further embodiments, the phase mask may not focus a region within an angle B (e.g., within at least 5°, about 15°) from the phase axis 1802, where the angle B is measured relative to the center of the laser beam 1609.

In even further embodiments, an adaptive phase-altering optical element 1627, for example, a spatial light modulator (SLM), can comprise the phase mask 1801. In still further embodiments, focusing the burst of pulses can comprise reflecting the burst of pulses off a spatial light modulator (SLM) comprising the phase mask 1801. In even further embodiments, a static phase-altering optical element 1703 can comprise a beam block and/or an axicon 1705. In still further embodiments, focusing the burst of pulses can comprise transmitting the burst of pulses through a beam block comprising the phase mask 1801. In still further embodiments, focusing the burst of pules can comprise transmitting the burst of pulses through an axicon 1705. In yet further embodiments, focusing the burst of pulses can comprise transmitting the burst of pulses through an axicon 1705 comprising the phase mask 1801. In some embodiments, although not shown, the beam block and/or axicon 1705 can be positioned in the collimation space 1617 instead of where it is shown in FIG. 17.

In some embodiments, the laser beam 1609 of a pulse of the burst of pulses can be focused using the optical apparatus 1601, 1701 discussed above. In further embodiments, the focused laser beam 1609 can comprise a line focus 1901 within the light guide plate 105. In even further embodiments, the line focus 1901 can be limited to a region internal to the light guide plate 105 corresponding to a region for a corresponding feature 117, 301, 501, 801, 1301 internal to the light guide plate 105 being generated (e.g., written).

In some embodiments, the burst of pulses impinges on the light guide plate 105 to form a feature of the plurality of features 117. The above sequence can be repeated to generate additional features of the plurality of features at a different location on the light guide plate that can be within 20 μm to about 200 μm from an existing feature of the plurality of features.

In some embodiments, after the features of the plurality of features are created using bursts of laser pulses, the light guide plate may be annealed at a temperature in a range from about 200° C. to about 1,000° C. for a time between about 5 minutes and 1 hour. Generally, annealing can be performed at a temperature greater than room temperature and less than the glass transition temperature of the material of the light guide plate, if the material comprises a glass transition temperature. As discussed with reference to Example C, annealing the light guide plate after generating the plurality of features can produce a feature with a more consistent refractive index profile and/or more consistent features across the plurality of features.

With reference to FIG. 1, light guide plates with internal features can be used as part of an apparatus in a method of emitting light. First, light 125 emitted from the light source 103 can be injected into the first edge 107 of the light guide plate 105. Then, the injected light 125 can propagate within the light guide plate 105. The propagating light can then impinge on a feature of the plurality of features 117. Subsequently, the propagating light 125 can pass through the first major surface 109 of the light guide plate 105 with a peak radiance oriented from about 0° to about 30° from a direction normal to the first major surface 109 of the light guide plate 105. In further methods, the propagating light 125 can pass through the first major surface 109 of the light guide plate 105 with a peak radiance oriented from about 0° to about 25° from a direction normal to the first major surface 109 of the light guide plate 105.

Examples A-C relate to methods of creating a plurality of features within the light guide plate using laser writing, as described above. For the example embodiments discussed, the light guide plate comprised 2 mm thick Iris® glass from Corning, a 355 nm laser operated to generate pulses with an average pulse width of about 38 ns, 700 pulses per burst, a repetition rate of 135 kHz, an f-theta lens was operated with an effective focal length of 163.4 mm and a working distance of 221.7 mm, and a feature spacing between the principal feature axis of one feature and the principal feature axis of an adjacent feature is about 200 μm, unless indicated otherwise.

### Example A

In example A, the number of pulses used to write a feature was varied. Using 100 pulses with a total energy of 2.9 μJ is around the lower end for generating features comprising a height of at least 1 μm. At the other extreme, using 800 pulses with a total energy of about 23.7 μJ where various imperfections and irregularities begin to appear in the features. In between these extremes, features can be generated readily. For example, 600 pulses with a total energy of about 17.8 μJ can be used to write a feature. Increasing the number of pulses between about 100 and about 800 increases the height of the feature written.

### Example B

In example B, the spacing (i.e., distance) between features was varied. Using an intended feature spacing of about 20 μm, only 5 of the intended 10 features were visible because pairs of adjacent features merged together. Increasing the spacing even slightly beyond 20 μm generated individual features as intended. For example, using a feature spacing of 40 μm, the desired number of features was generated, but the features were slightly irregular. Further increasing the feature spacing to 60 μm produced features where each feature was substantially the same as the others. The spacing can be increased even further to at least a spacing of 200 μm with no adverse feature attributes. As mentioned earlier, it can be desirable to keep the feature spacing between about 20 μm and 200 μm to produce sufficient radiance given the low percentage of light directed out of the light guide plate by any given feature. Additionally, it can be desirable for the feature spacing to decrease as the distance from the light source decreases in order to keep the radiance substantially the same across the light guide plate.

### Example C

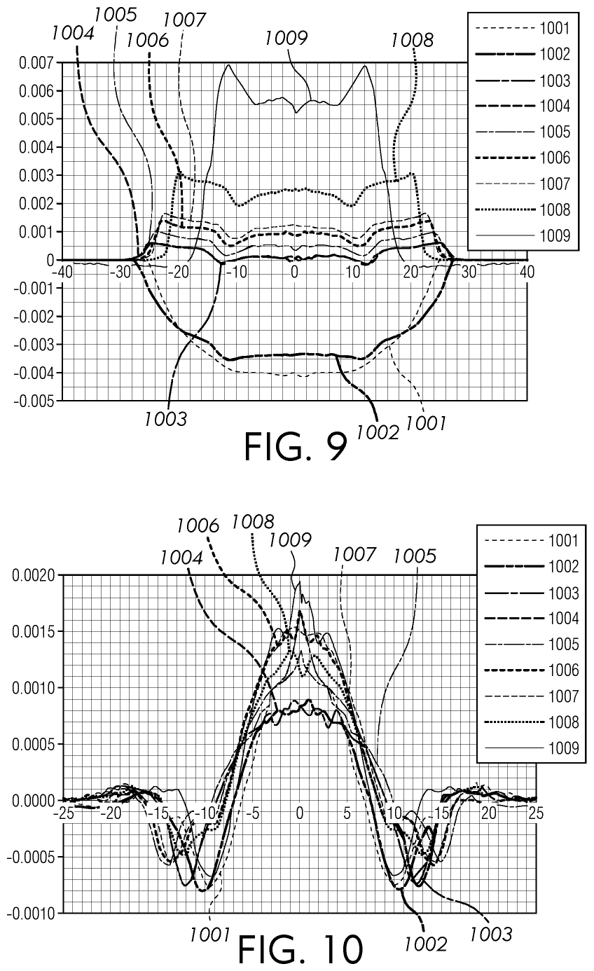

Example C illustrates the refractive index profile across a feature going from the first edge to the second edge of the light guide plate, as shown in FIGS. 9-10. For analysis, a feature was measured at 9 locations equally spaced along the height of the feature (i.e., along the thickness direction of the light guide plate) going from closer to the first major surface toward the second major surface with corresponding profiles show via 1001-1009, respectively. FIG. 9 corresponds to a feature with no annealing. FIG. 10 corresponds to a feature that was annealed for 30 minutes at 620° C. In FIGS. 9-10, the vertical axis represents the difference between the refractive index of the feature and the refractive index of the light guide plate. For the unannealed feature, as shown in FIG. 9, the refractive index increases as the distance from the first major surface increases. With the exception of 1001-1003, all of the profiles for the unannealed feature had a positive refractive index difference from −15 to 15 on the horizontal axis. As such, the first and second portions may be arranged substantially as shown in FIG. 3. After annealing, as shown in FIG. 10, the refractive index profile was more consistent across the height of the feature. The center of the feature had a positive refractive index difference while the periphery has slightly negative portions. As such, the first and second portions may be arranged substantially as shown in FIG. 2.

### Example D

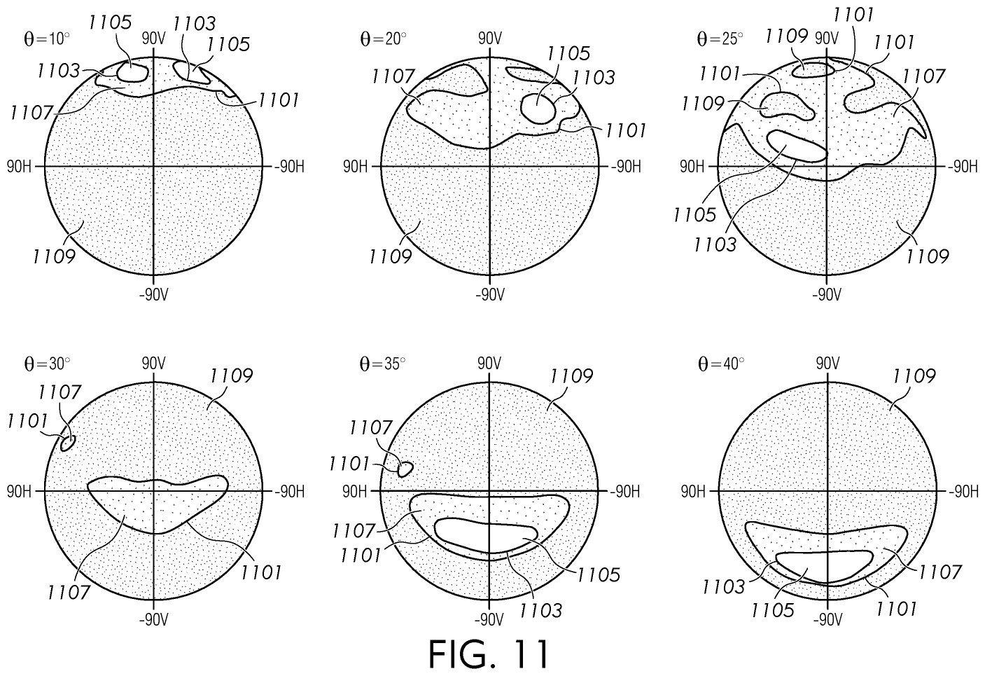

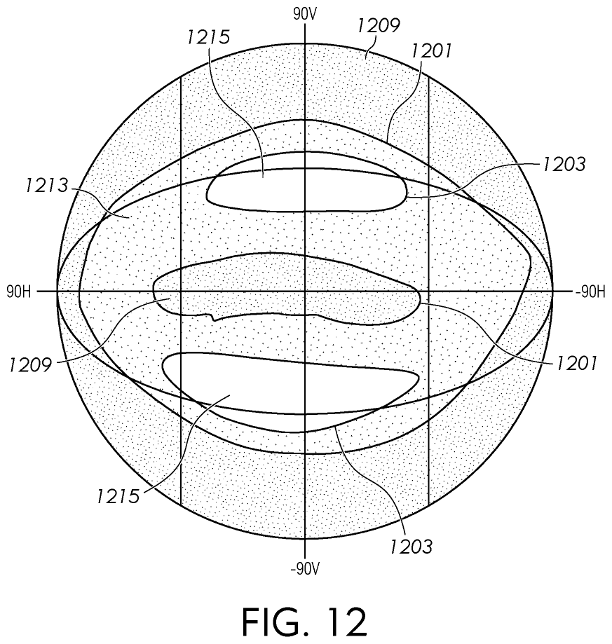

Example D illustrates the regions of maximum radiance relative to a direction normal to the first major surface 109 of the light guide plate for features with different tilt angles and with or without a side reflector 118. As used to describe FIGS. 11-12, the term “vertical” refers to a direction running from the light source 103 towards the first edge 107 of the light guide plate 105 while the term “horizontal” refers to a direction perpendicular to the “vertical” direction running from the third edge 807 towards the fourth edge 809 of the light guide plate 105. Both the “vertical” and “horizontal” angles are measures relative to a direction normal to the first major surface 109 of the light guide plate 105.

FIG. 11 is a schematic representation of computed angular distributions of light leaving the first major surface of a light guide plate according to embodiments described herein when the light guide plate has features with different tilt angles. The features comprise a height of 1 mm, a maximum width of 20 μm, and a refractive index that is greater than the refractive index of the light guide plate by 0.015. The light guide plate comprises a thickness of 2 mm. The apparatus comprises a back reflector but not a side reflector. For each sub-plot, the x-axis (i.e., horizontal axis) is the horizontal angle in degrees relative to a direction normal to the first major surface of the light guide plate while the y-axis (i.e., vertical axis) is the vertical angle in degrees relative to a direction normal to the first major surface of the light guide plate. A simplified representation of the radiance in W/m² is represented by the contour lines 1101 delineating regions of low radiance 1109 from regions of intermediate radiance 1107 and the contour lines 1103 delineating regions of intermediate radiance 1107 from regions of high radiance 1105. Values are physically meaningful within circle bounded by −90H, 90H, −90V, and 90V. Going from left to right in the top row, the tilt angle of the features are 10°, 20° and 25°. Going from left to right in the bottom row, the tilt angle of the features is 30°, 35° and 40°. For a tilt angle of 35°, high radiance 1105 occurs in a range from −30° to 30° on the horizontal axis and from −45° to about −25° on the vertical axis. For a tilt angle of 40°, the peak radiance is localized from −25° to 25° on the horizontal axis and mostly below −45° on the vertical axis. For a tilt angle of 30°, the maximum radiance is in a wide swath from −45° to 45° on the horizontal axis and from −25° to 15° on the vertical axis. For a tilt angle of 25°, the maximum radiance is around −20° on the horizontal axis and 15° on the vertical axis. For tilt angles less than 20°, the maximum radiance is beyond 45° on the vertical axis. Based on this data, the maximum radiance without a side reflector 118 is within 30° of normal for tilt angles from about 25° to about 35°. For a tilt angle of about 30°, the region of maximum radiance includes the normal direction (i.e., 0°).

FIG. 12 illustrates an angular distribution of light leaving the first major surface of a light guide plate according to the embodiments described herein when the example embodiment from FIG. 11 with a tilt angle of 35° further comprises a side reflector. A simplified representation of the radiance in Watts per meter squared (W/m²) is represented by the contour lines 1201 delineating regions of low radiance 1209 from regions of intermediate radiance 1213 and the contour lines 1203 delineating regions of intermediate radiance 1213 from regions of high radiance 1215. FIG. 12 resembles the middle panel of the top row from FIG. 11 in that they both have maximum radiance from −30° to 10° on the horizontal axis and from −45° to about −25° on the vertical axis, but FIG. 12 has an additional peak in radiance from −30° to about 20° on the horizontal axis and from about 30° to about 45° on the vertical axis. Essentially, adding the side reflectors creates another peak in intensity at the opposite location on the vertical axis and roughly centered on the horizontal axis. Applying this concept to the embodiments in FIG. 11, tilt angles between about 25° and about 35° should produce increased intensities within 30° or normal when a side reflector is added.

### Example E

Example E illustrates the regions of maximum radiance relative to a direction normal to the first major surface 109 of the light guide plate for features with and without a plurality of cracks. As used to describe FIGS. 14-15, the term “vertical” refers to a direction running from the light source 103 towards the first edge 107 of the light guide plate 105 while the term “horizontal” refers to a direction perpendicular to the “vertical” direction running from the third edge 807 towards the fourth edge 809 of the light guide plate 105. Both the “vertical” and “horizonal” angles are measures relative to a direction normal to the first major surface 109 of the light guide plate 105.

FIGS. 14-15 are schematic representations of experimentally measured angular distributions of light leaving the first major surface of a light guide plate according to embodiments described herein. FIG. 14 corresponds to a light guide plate with features generated using a line focus but not a phase mask 1801. FIG. 15 corresponds to a light guide plate with features generated using phase mask 1801 to generate a line focus, which features comprise a plurality of cracks substantially positioned within about 10° of a corresponding crack plane. The light guide plates used for FIGS. 14-15 comprised 1.1 mm thick Iris® glass from Corning, the features comprised a height of 700 μm, and the features were generated at a non-zero tilt angle using a 1064 nm laser. The apparatus comprised a back reflector but not a side reflector. For each sub-plot, the x-axis (i.e., horizontal axis) is the horizontal angle in degrees relative to a direction normal to the first major surface of the light guide plate while the y-axis (i.e., vertical axis) is the vertical angle in degrees relative to a direction normal to the first major surface of the light guide plate. A simplified representation of the radiance in W/m² is represented by the contour lines 1401, 1501 delineating regions of low radiance 1409, 1509 from regions of intermediate radiance 1407, 1507 and the contour lines 1403, 1503 delineating regions of intermediate radiance 1407, 1507 from regions of high radiance 1405, 1407. Values are physically meaningful within circle bounded by −90H, 90H, −90V, and 90V.

FIG. 15 comprises a region of high radiance 1505 in a range from 0° to 45° on the horizontal axis and from 55° to 70° on the vertical axis. FIG. 14 comprises a region of high radiance 1405 from −30° to about 30° on the horizontal axis and from 35° to 70° on the vertical axis. Compared to FIG. 15, the region of high radiance 1405 in FIG. 14 is more centered in both the horizontal direction and the vertical direction. Also, the region of high radiance 1405 in FIG. 14 is broader (e.g., larger area) than the region of high radiance 1505 in FIG. 14. Looking at regions of moderate radiance, FIG. 15 comprises two distinct regions of moderate radiance 1507 that do not include the origin (i.e. 0°, 0°) while FIG. 14 comprises a single broad area of moderate radiance 1407 that does include the origin. As such, it can be seen that providing features comprising controlled cracking using a phase mask (e.g., phase mask 1801) can produce more centered and broader regions of high radiance and moderate radiance compared to features generated without using a phase mask.

### Example F

Example F demonstrates the light extraction capability of a feature according to the embodiments of the disclosure. The features were generated according to the method described for Example E with one feature comprising a plurality of cracks substantially positioned within about 10° of a corresponding crack plane generated using the phase mask 1801 while the other feature did not. The feature generated using the phase mask demonstrated an increase is light extraction of 235% compared to the other feature. As such, providing controlled cracking (e.g., plurality of cracks substantially positioned within about 10° or a corresponding crack plane) can provide for increased light extraction.

The embodiments of the disclosure can provide for the generation of features internal to the light guide plate. Providing features internal to the light guide plate can increase light extraction because the features can cover a large cross-sectional area of the light guide plate. Providing features internal to the light guide plate can reduce (e.g., decrease) the incidence of damage (e.g., fracture) to the light guide plate because the surface(s) of the light guide plate are not modified. Providing features internal to the light guide plate can avoid issues associated with coupling between a surface of the light guide plate and another surface because the light guide plate can present a uniform and/or planar surface. Providing features internal to the light guide plate can enable the light guide plate to direct light out of the first major surface with a peak radiance oriented from 0° to 30° from a direction normal to the first major surface. The extraction profile (e.g., peak radiance) can be controlled by adjusting the tilt angle of a feature and/or using different tilt angles in the same light guide plate. Likewise, the extraction profile can be controlled by adjusting an angle between a crack plane relative to the first edge based on a position along the width of the light guide plate.

The embodiments of the disclosure can provide for spacings between an adjacent pair of features of the plurality of features of about 20 μm or more. Providing a small spacing (e.g., about 20 μm) can enable uniform and/or even light extraction and/or the reduction of bright spots of light extracted from the light guide plate. Providing a small spacing can enable a wider range of spacings to be used within a single light guide plate, which can enable more uniform and/or even light extraction across the length of the light guide plate. Such a spacing pattern may provide the technical benefit of evenly distributing light between the feature paths because feature paths are denser at locations farther away from the light source with lower light intensity. In some embodiments, the spacing can comprise the spacing between feature paths, which can decrease as the distance from the light source and/or first edge increases. In some embodiments, the spacing can comprise the spacing between a pair of adjacent features on a common feature path, and the spacing between adjacent pairs of features on a common feature path can decrease as the corresponding feature path's distance from the light source and/or the first edge increases. In some embodiments, a first pair of adjacent features on a first feature path can be staggered relative to a second pair of adjacent features on a second feature path adjacent to the first feature path. Such a staggered design can provide the technical benefit of distributing the light leaving the light guide plate more evenly along the length of the light guide plate than having features aligned between feature paths. Additionally, the evenness and/or uniformity of the light can be increased by having a first feature comprise a first height that is less than a second height of a second feature when the second feature is positioned farther from the first edge and/or light source than the second edge.

The embodiments of the disclosure can provide for increased light extraction per feature. Providing features internal to the light guide plate can cover a large cross-sectional area of the light guide plate. Providing features comprising a slight refractive index difference (e.g., in a range from about 0.0005 to about 0.015) compared to the bulk of the light guide plate can increase refraction of light by the features because less light may be reflected towards the light source. Annealing the light guide plate after generating the plurality of features can produce a feature with a more consistent refractive index profile and/or more consistent features across the plurality of features. Light extraction per feature can be increased by providing features comprising controlled cracking (e.g., comprising a plurality of cracks substantially positioned within about 10° or a corresponding crack plane), as demonstrated by the examples. The light extraction of a feature can be increased by adjusting the tilt angle of the feature based on the distance from the first edge.

The embodiments of the disclosure can provide for features comprising a plurality of cracks. Providing features comprising controlled cracking (e.g., comprising a plurality of cracks substantially positioned within about 10° or a corresponding crack plane) can increase light extraction. Providing features comprising controlled cracking (e.g., using a phase mask) can produce more centered and broader regions of high radiance and moderate radiance. Providing a phase mask can enable the laser beam to focus into a line focus within the light guide plate for the generation of features internal to the light guide plate using a single burst of pulses. Providing a phase mask can enable the generation of consistent and/or reproducible cracking patterns in features. Providing a phase mask comprising a region within a predetermined angle of a phase axis can produce features comprising controlled cracking (e.g., a plurality of cracks substantially positioned within a predetermined angle of a crack plane), which can enable enhanced light extraction and/or broader regions of increased (e.g., high) radiance. Providing a phase mask comprising a non-focusing central portion and/or outer peripheral portion can limit the length of the line focus, which can enable the production of features that are internal to the light guide plate.

As used herein, the terms “the,” “a,” or “an,” mean “at least one,” and should not be limited to “only one” unless explicitly indicated to the contrary. Thus, for example, reference to “a component” comprises embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to comprise the specific value or endpoint referred to. If a numerical value or endpoint of a range in the specification recites “about,” the numerical value or endpoint of a range is intended to comprise two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof, shall be construed as synonymous and open ended, unless otherwise indicated. A list of elements following the transitional phrases comprising or including is a non-exclusive list, such that elements in addition to those specifically recited in the list may also be present.

While various embodiments have been described in detail with respect to certain illustrative and specific embodiments thereof, the present disclosure should not be considered limited to such, as numerous modifications and combinations of the disclosed features are possible without departing from the scope of the following claims.

What is claimed is:

1. An apparatus comprising:
a light guide plate comprising a first major surface, a second major surface, a first edge extending between the first major surface and the second major surface, and a thickness defined between the first major surface and the second major surface;
a plurality of features internal to the light guide plate, one or more features of the plurality of features comprising:
a first refractive index;
a height in a direction of the thickness of the light guide plate;
a tilt angle defined between a central axis of a feature of the one or more features and a direction of the thickness of the light guide plate;
a spacing between a pair of adjacent features of the plurality of features is in a range from about 20 micrometers to about 200 micrometers; and
a light source positioned to emit light into the first edge of the light guide plate,
wherein a difference between the first refractive index and a refractive index of the light guide plate is about 0.0005 or more.

2. The apparatus of claim 1, wherein a width of the one or more features is in a range from about 5 micrometers to about 100 micrometers.

3. The apparatus of claim 1, wherein the first refractive index of the one or more features is greater than the refractive index of the light guide plate.

4. The apparatus of claim 3, wherein the one or more features further comprise a second refractive index less than the refractive index of the light guide plate.

5. The apparatus of claim 1, wherein the difference between the first refractive index of the one or more features and the refractive index of the light guide plate is in a range from about 0.0005 to about 0.015.

6. The apparatus of claim 1, wherein the tilt angle is in a range from about 20° to about 40°.

7. The apparatus of claim 1, wherein the tilt angle is in a range from about 25° to about 35°.

8. The apparatus of claim 1, wherein the height of the one or more features increases as a distance of the one or more features from the first edge increases.

9. The apparatus of claim 1, wherein the height of the one or more features is in a range from 5 micrometers to about 3 millimeters.

10. The apparatus of claim 1, wherein a feature of the one or more features comprises a plurality of cracks extending radially outward from the central axis of the feature.

11. The apparatus of claim 10, wherein substantially all of the cracks of the plurality of cracks are within 15° of a crack plane comprising the central axis of the feature.

12. The apparatus of claim 11, wherein substantially all of the cracks of the plurality of cracks are within 10° of the crack plane.

13. The apparatus of claim 1, wherein the first and second major surfaces of the light guide plate comprise a quadrilateral shape, the light guide plate further comprising a second edge extending between the first and second major surfaces and opposite the first edge, a third edge extending between the first and second major surfaces, and a fourth edge extending between the first and second major surfaces and opposite the third edge, a length of the light guide plate defined between the first edge and the second edge, a width of the light guide plate defined between the third edge and the fourth edge, the light guide plate comprising a first feature path extending from the third edge of the light guide plate to the fourth edge of the light guide plate, and the one or more features comprising a plurality of first features positioned on the first feature path.

14. The apparatus of claim 13, further comprising a second feature path and a third feature path each extending from the third edge of the light guide plate to the fourth edge of the light guide plate, the one or more features comprising a plurality of second features positioned on the second feature path, the second feature path positioned between the first feature path and the third feature path, and the first feature path positioned closer to the first edge than the second feature path.

15. The apparatus of claim 14, wherein the first feature path, the second feature path, and the third feature path each extend substantially parallel to the first edge.

16. The apparatus of claim 14, wherein the spacing comprises a first path spacing between the first feature path and the second feature path, the spacing further comprising a second path spacing between the second feature path and the third feature path, and wherein the second path spacing is less than the first path spacing.

17. The apparatus of claim 14, wherein the pair of adjacent features comprises a first pair of adjacent features of the first plurality of features positioned on the first feature path, the spacing comprising a first feature spacing along the first feature path between the first pair of adjacent features of the plurality of first features.

18. The apparatus of claim 17, wherein the pair of adjacent features comprises a second pair of adjacent features of the second plurality of features positioned on the second feature path, the spacing comprising a second feature spacing along the second feature path between the second pair of features of the plurality of second features.

19. The apparatus of claim 18, wherein the first pair of adjacent features is staggered relative to the second pair of adjacent features.

20. The apparatus of claim 14, wherein a height of a feature of the plurality of second features positioned along the second feature path is greater than a height of a feature of the plurality of first features positioned along the first feature path.

21. The apparatus of claim 14, wherein a first tilt angle of a feature of the plurality of first features positioned along the first feature path is greater than a second tilt angle of a feature of the plurality of second features positioned along the second feature path, and the first tilt angle and the second tilt angle are measured relative to the direction of the thickness of the light guide plate.

22. The apparatus of claim 13, wherein a feature of the plurality of first features comprises:
a plurality of cracks extending radially outward from the central axis of the feature, wherein substantially all of the cracks of the plurality of cracks of the feature of the one or more features are within 15° of a crack plane comprising the central axis of the feature; and
a crack plane angle defined between the crack plane and a tilt plane, the tilt plane comprising the central axis and extending in a direction of the width of the light guide plate.

23. The apparatus of claim 22, wherein the crack plane angle is in a range from 0° to about 30°.

24. The apparatus of claim 22, wherein the crack plane angle is in a range from 0° to about 5°.

25. The apparatus of claim 22, wherein the plurality of first features comprises a first outer feature, a second outer feature, and a central feature positioned between the first outer feature and the second outer feature, and wherein a magnitude of the crack plane angle of the central feature is less than a magnitude of the crack plane angle of the first outer feature, and a magnitude of the crack plane angle of the central feature is less than a magnitude of the crack plane angle of the second outer feature.

26.-43. (canceled)
